(19) United States
(12) Patent Application Publication
(10) Pub. No.: US 2025/0199386 A1
(43) Pub. Date: Jun. 19, 2025

(54) IMAGE PROCESSING APPARATUS, IMAGE PROCESSING METHOD, IMAGE PROCESSING PROGRAM, AND SYSTEM

(71) Applicant: FUJIFILM Corporation, Tokyo (JP)

(72) Inventors: Kazuyuki ITAGAKI, Saitama-shi (JP); Toshihiro OOGUNI, Saitama-shi (JP)

(73) Assignee: FUJIFILM Corporation, Tokyo (JP)

(21) Appl. No.: 19/069,802

(22) Filed: Mar. 4, 2025

Related U.S. Application Data
(63) Continuation of application No. PCT/JP2023/029090, filed on Aug. 9, 2023.

(30) Foreign Application Priority Data
Sep. 5, 2022 (JP) 2022-140823

(51) Int. Cl. G03B 21/14; H04N 5/74

(52) U.S. Cl. CPC G03B 21/145; H04N 5/74

(57) ABSTRACT

An image processing apparatus is configured to: acquire virtual projection surface data related to a virtual projection surface and virtual projection apparatus data related to a virtual projection apparatus; acquire first image data obtained by an imaging apparatus; generate second image data representing a second image in which the virtual projection surface and the virtual projection apparatus are displayed on a first image represented by the first image data, based on the first image data, the virtual projection surface data, and the virtual projection apparatus data, and output the second image data; and generate assist information representing a deviation between an installation state of a projection apparatus based on the first image and an installation state of the virtual projection apparatus represented by the virtual projection apparatus data, based on a recognition result of an operator who installs the projection apparatus, which is included in the first image.

### CROSS-REFERENCE TO RELATED APPLICATIONS

This is a continuation of International Application No. PCT/JP2023/029090 filed on Aug. 9, 2023, and claims priority from Japanese Patent Application No. 2022-140823 filed on Sep. 5, 2022, the entire content of which is incorporated herein by reference.

### BACKGROUND OF THE INVENTION

### 1. Field of the Invention

The present invention relates to an image processing apparatus, an image processing method, a storage medium storing an image processing program, and a system.

### 2. Description of the Related Art

JP2018-005115A discloses, in order to facilitate installation and adjustment of a projection type display device, a projection image adjustment system that stores virtual environment installation information indicating an installation state of the projection type display device installed to obtain a desired image projection state onto a projection target object in a virtual space generated by a computer and control setting values of the projection type display device at that time, acquires real environment installation information indicating an installation state of the projection type display device in a real space, and via a control unit that controls an operation of the projection type display device, corrects the control setting values based on the virtual environment installation information and the real environment installation information to eliminate any difference between a projection state of an image in the real space and a desired image projection state, and controls the operation of the projection type display device based on the corrected control setting values.

WO2007/072695A discloses an image projection apparatus that projects a correction image corresponding to a projection surface, the image projection apparatus comprising: an imaging unit that captures a projected image; a correction parameter calculation unit that calculates a correction parameter for correcting a distortion of the image caused by the projection surface, based on the captured image; a correction unit that generates the correction image by correcting the image using the correction parameter; a reproducibility calculation unit that calculates reproducibility of the correction image with respect to an original image; an image generation unit that generates a guidance image related to the reproducibility; and a control unit that controls projection of the guidance image.

JP2000-081601A discloses, in order to facilitate installation and adjustment, a projector that projects an image displayed on an image display unit onto a surface to be projected through a projection lens, the projector comprising: a lens drive unit that drives the projection lens; a reception unit that receives an input of at least one projection condition; a parameter determination unit that determines a control parameter of the lens drive unit based on the received projection condition; and a control unit that controls the lens drive unit based on the determined control parameter.

### SUMMARY OF THE INVENTION

One embodiment according to the technique of the present disclosure provides an image processing apparatus, an image processing method, a storage medium storing an image processing program, and a system capable of efficiently adjusting a projection state.
(1)
   An image processing apparatus comprising a processor,
   in which the processor is configured to:
      acquire virtual projection surface data related to a virtual projection surface and virtual projection apparatus data related to a virtual projection apparatus;
      acquire first image data obtained by an imaging apparatus;
      generate second image data representing a second image in which the virtual projection surface and the virtual projection apparatus are displayed on a first image represented by the first image data, based on the first image data, the virtual projection surface data, and the virtual projection apparatus data, and output the second image data to an output destination; and
      generate assist information for bringing a projection state via a projection apparatus close to a projection state represented by at least one of the virtual projection surface data or the virtual projection apparatus data and output the assist information to the output destination.
(2)
   The image processing apparatus according to (1),
   in which the processor is configured to generate third image data representing a third image in which the assist information is displayed on the second image and output the third image data to the output destination.
(3)
   The image processing apparatus according to (1) or (2), in which the processor is configured to generate audio data representing the assist information and output the audio data to the output destination.
(4)
   The image processing apparatus according to any one of (1) to (3), in which the projection state via the projection device includes at least one of an installation state of the projection apparatus or a state of a projection surface corresponding to the projection apparatus.
(5)
   The image processing apparatus according to (4),
   in which the projection state includes the installation state of the projection apparatus, and
   the processor is configured to generate the assist information representing a deviation between the installation state of the projection apparatus based on the first image and an installation state of the virtual projection apparatus represented by the virtual projection apparatus data.
(6)
   The image processing apparatus according to (5),
   in which the installation state of the projection apparatus includes at least one of an installation form of the projection apparatus or an installation position of the projection apparatus.
(7)
   The image processing apparatus according to (5) or (6),
   in which the processor is configured to generate the assist information based on a recognition result of an operator who installs the projection apparatus, which is included in the first image.
(8)
   The image processing apparatus according to any one of (4) to (7),
   in which the projection state includes the state of the projection surface, and
   the state of the projection surface includes at least one of a position of the projection surface, a size of the projection surface, or an inclination of the projection surface.
(9)
   The image processing apparatus according to (8),
   in which the state of the projection surface includes at least one of the position or the size of the projection surface, and
   the processor is configured to generate the assist information for setting a projection condition of the projection apparatus that changes at least one of the position or the size of the projection surface.
(10)
   The image processing apparatus according to (8) or (9),
   in which the state of the projection surface includes the inclination of the projection surface, and
   the processor is configured to generate the assist information for adjusting the inclination of the projection surface.
(11)
   The image processing apparatus according to any one of (1) to (10),
   in which the processor is configured to generate the assist information for bringing an installation position of the projection apparatus close to a position different from an installation position of the virtual projection apparatus represented by the virtual projection apparatus data and for bringing a state of a projection surface corresponding to the projection apparatus close to a state of the virtual projection surface represented by the virtual projection surface data.
(12)
   The image processing apparatus according to any one of (1) to (10),
   in which the processor is configured to generate the assist information for bringing a state of a projection surface corresponding to the projection apparatus close to a state of the virtual projection surface represented by the virtual projection surface data at an installation position of the projection apparatus based on the first image.
(13)
   The image processing apparatus according to any one of (1) to (12), in which the output destination includes the projection apparatus capable of projecting the assist information.
(14)
   The image processing apparatus according to any one of (1) to (13),
   in which the output destination includes a wearable display device that is worn by an operator who installs the projection apparatus and that is capable of displaying the assist information.
(15)
   The image processing apparatus according to any one of (1) to (14),
   in which the image processing apparatus is provided in an information processing terminal comprising a display device capable of displaying the assist information, and the output destination includes the display device.
(16)
   The image processing apparatus according to (15),
   in which the information processing terminal comprises the imaging apparatus.
(17)
   An image processing method executed by a processor included in an image processing apparatus, the image processing method comprising:
   acquiring virtual projection surface data related to a virtual projection surface and virtual projection apparatus data related to a virtual projection apparatus;
   acquiring first image data obtained by an imaging apparatus;
   generating second image data representing a second image in which the virtual projection surface and the virtual projection apparatus are displayed on a first image represented by the first image data, based on the first image data, the virtual projection surface data, and the virtual projection apparatus data, and outputting the second image data to an output destination; and
   generating assist information for bringing a projection state via a projection apparatus close to a projection state represented by at least one of the virtual projection surface data or the virtual projection apparatus data and outputting the assist information to the output destination.
(18)
   A non-transitory-computer-readable storage medium storing an image processing program for causing a processor included in an image processing apparatus to execute a process comprising:
   acquiring virtual projection surface data related to a virtual projection surface and virtual projection apparatus data related to a virtual projection apparatus;
   acquiring first image data obtained by an imaging apparatus;
   generating second image data representing a second image in which the virtual projection surface and the virtual projection apparatus are displayed on a first image represented by the first image data, based on the first image data, the virtual projection surface data, and the virtual projection apparatus data, and outputting the second image data to an output destination; and
   generating assist information for bringing a projection state via a projection apparatus close to a projection state represented by at least one of the virtual projection surface data or the virtual projection apparatus data and outputting the assist information to the output destination.
(19)
   A system comprising:
   an image processing apparatus;
   an imaging apparatus; and
   a projection apparatus,
   in which virtual projection surface data related to a virtual projection surface and virtual projection apparatus data related to a virtual projection apparatus are acquired,
   first image data obtained by the imaging apparatus is acquired,
   second image data representing a second image in which the virtual projection surface and the virtual projection apparatus are displayed on a first image represented by the first image data is generated based on the first image data, the virtual projection surface data, and the virtual projection apparatus data and the second image data is output to an output destination, and
   assist information for bringing a projection state via the projection apparatus close to a projection state represented by at least one of the virtual projection surface data or the virtual projection apparatus data is generated and the assist information is output to the output destination.

According to the present invention, it is possible to provide an image processing apparatus, an image processing method, a storage medium storing an image processing program, and a system capable of efficiently adjusting a projection state.

### BRIEF DESCRIPTION OF THE DRAWINGS

FIG. 1 is a schematic diagram showing an example of the projection apparatus 10 that is a target for installation support by an image processing apparatus according to an embodiment.

FIG. 2 is a schematic diagram showing an example of an internal configuration of the projection portion 1 shown in FIG. 1.

FIG. 3 is a schematic diagram showing an external configuration of the projection apparatus 10.

FIG. 4 is a schematic cross-sectional view of an optical unit 106 of the projection apparatus 10 shown in FIG. 3.

FIG. 5 is a diagram showing an example of an appearance of an information processing terminal 50.

FIG. 6 is a diagram showing an example of a hardware configuration of the information processing terminal 50.

FIG. 7 is a diagram showing an example of a system of the embodiment.

FIG. 8 is a diagram showing an example of display of a second image with the information processing terminal 50.

FIG. 9 is a diagram showing an example of adjustment of a projection state of the projection apparatus 10 based on the display of the second image.

FIG. 10 is a flowchart showing an example of the adjustment of the projection state of the projection apparatus 10.

FIG. 11 is a diagram showing an example of a marker for adjusting an installation form of the projection apparatus 10.

FIG. 12 is a diagram showing an example of display for prompting a change of a mount rotation axis.

FIG. 13 is a diagram showing an example of a marker for adjusting an installation position of the projection apparatus 10.

FIG. 14 is a diagram showing an example of detection of a position of the projection apparatus 10 based on a marker.

FIG. 15 is a diagram showing each point recognized by the information processing terminal 50 in a camera coordinate system of FIG. 14.

FIG. 16 is a diagram showing each point recognized by the information processing terminal 50 in a plane of a rear surface of the projection apparatus 10.

FIG. 17 is a diagram showing an example of display for prompting the adjustment of the installation position of the projection apparatus 10.

FIG. 18 is a diagram showing another example of the marker for adjusting the installation position of the projection apparatus 10.

FIG. 19 is a diagram (part 1) showing an example of output of assist information based on a recognition result of an operator who installs the projection apparatus 10.

FIG. 20 is a diagram (part 2) showing an example of the output of the assist information based on the recognition result of the operator who installs the projection apparatus 10.

FIG. 21 is a diagram (part 3) showing an example of the output of the assist information based on the recognition result of the operator who installs the projection apparatus 10.

FIG. 22 is a diagram (part 4) showing an example of the output of the assist information based on the recognition result of the operator who installs the projection apparatus 10.

FIG. 23 is a diagram showing an example of an inclination of a projection surface 11.

FIG. 24 is a diagram showing an example of a marker grid projected by the projection apparatus 10.

FIG. 25 is a diagram showing an example of a marker grid of a virtual projection surface 11V displayed by the information processing terminal 50.

FIG. 26 shows an example of a marker grid 241 of the projection apparatus 10 in a camera plane of an imaging apparatus 65.

FIG. 27 shows an example of a marker grid 251 of the virtual projection surface 11V in the camera plane of the imaging apparatus 65.

FIG. 28 shows an example of a quadrangle connecting each point in a case where a plane of the virtual projection surface 11V is set as a reference plane.

FIG. 29 is a diagram showing an example of display for prompting adjustment of the inclination of the projection surface 11 in the example of FIG. 28.

FIG. 30 shows another example of the quadrangle connecting each point in a case where the plane of the virtual projection surface 11V is set as the reference plane.

FIG. 31 is a diagram showing an example of display for prompting the adjustment of the inclination of the projection surface 11 in the example of FIG. 30.

FIG. 32 is a diagram showing an example of a state in which a part of the marker grid 241 straddles another plane (wall 6a and wall 6b).

FIG. 33 is a diagram showing an example of the marker grid 241 used for correcting an end of the projection surface 11.

FIG. 34 is a diagram showing an example of a simulation result of installing a virtual projection apparatus 10V on a ceiling 6d.

FIG. 35 is a diagram showing an example of a simulation result of installing the virtual projection apparatus 10V on a floor 6e.

FIG. 36 is a diagram (part 1) showing an example of processing of aligning a center of the projection surface 11.

FIG. 37 is a diagram (part 2) showing an example of the processing of aligning the center of the projection surface 11.

FIG. 38 is a diagram showing an example of the output of the assist information using the projection apparatus 10.

FIG. 39 is a schematic diagram showing another external configuration of the projection apparatus 10.

FIG. 40 is a schematic cross-sectional view of the optical unit 106 of the projection apparatus 10 shown in FIG. 39.

### DESCRIPTION OF THE PREFERRED EMBODIMENTS

Hereinafter, an example of an embodiment of the present invention will be described with reference to the drawings.

### Embodiment

### Projection Apparatus 10 That is Target for Installation Support by Image Processing Apparatus According to Embodiment

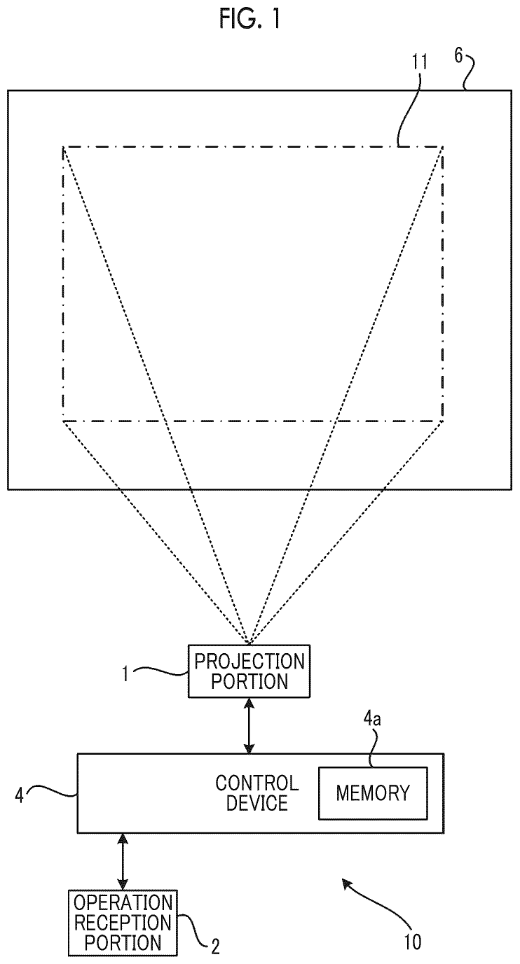

FIG. 1 is a schematic diagram showing an example of the projection apparatus 10 that is a target for installation support by an image processing apparatus according to an embodiment.

The image processing apparatus according to the embodiment can be used, for example, to support installation of the projection apparatus 10. The projection apparatus 10 comprises a projection portion 1, a control device 4, and an operation reception portion 2. The projection portion 1 is composed of, for example, a liquid crystal projector or a projector using liquid crystal on silicon (LCOS). In the following description, it is assumed that the projection portion 1 is a liquid crystal projector.

The control device 4 is a control device that controls projection performed by the projection apparatus 10. The control device 4 is a device including a control unit composed of various processors, a communication interface (not shown) for communicating with each portion, and a memory 4a such as a hard disk, a solid-state drive (SSD), or a read-only memory (ROM) and integrally controls the projection portion 1.

Examples of the various processors of the control unit of the control device 4 include a central processing unit (CPU) which is a general-purpose processor that executes a program to perform various types of processing, a programmable logic device (PLD) which is a processor capable of changing a circuit configuration after manufacture such as a field-programmable gate array (FPGA), a dedicated electrical circuit which is a processor having a circuit configuration exclusively designed to execute specific processing such as an application-specific integrated circuit (ASIC), or the like.

More specifically, a structure of these various processors is an electrical circuit in which circuit elements such as semiconductor elements are combined. The control unit of the control device 4 may be configured with one of the various processors or may be configured with a combination of two or more processors of the same type or different types (for example, a combination of a plurality of FPGAs or a combination of a CPU and an FPGA).

The operation reception portion 2 detects an instruction from a user by receiving various operations from the user. The operation reception portion 2 may be a button, a key, a joystick, or the like provided in the control device 4 or may be a reception portion or the like that receives a signal from a remote controller for remotely operating the control device 4.

A projection object 6 is an object such as a screen or a wall having a projection surface on which a projection image is displayed by the projection portion 1. In the example shown in FIG. 1, the projection surface of the projection object 6 is a rectangular plane.

A projection surface 11 shown by a dot-dashed line is a region irradiated with projection light by the projection portion 1 in the projection object 6. In the example shown in FIG. 1, the projection surface 11 is rectangular. The projection surface 11 is a part or the entirety of a projectable range in which the projection can be performed by the projection portion 1.

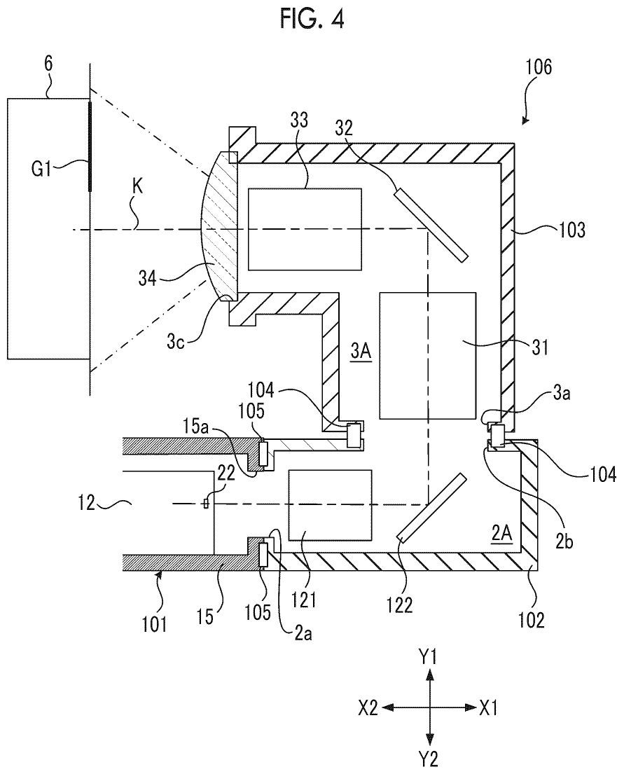

The projection portion 1, the control device 4, and the operation reception portion 2 are implemented by, for example, a single device (for example, see FIGS. 3 and 4). Alternatively, the projection portion 1, the control device 4, and the operation reception portion 2 may be separate devices that cooperate by communicating with each other.

### Internal Configuration of Projection Portion 1 Shown in FIG. 1

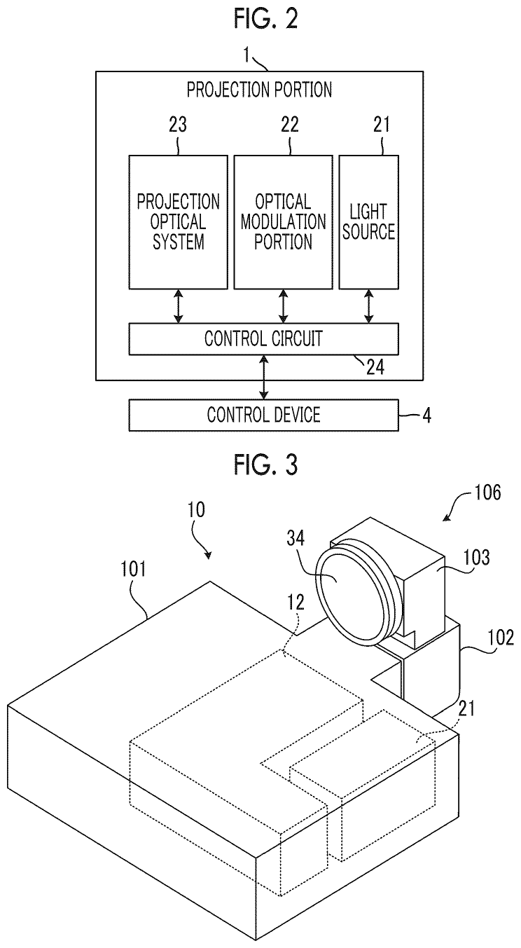

FIG. 2 is a schematic diagram showing an example of an internal configuration of the projection portion 1 shown in FIG. 1.

As shown in FIG. 2, the projection portion 1 comprises a light source 21, an optical modulation portion 22, a projection optical system 23, and a control circuit 24.

The light source 21 includes a light emitting element such as a laser or a light emitting diode (LED) and emits, for example, white light.

The optical modulation portion 22 is composed of three liquid crystal panels that emit each color image by modulating, based on image information, each color light beam which is emitted from the light source 21 and is separated into three colors of red, blue, and green by a color separation mechanism (not shown). Filters of red, blue, and green may be mounted in each of the three liquid crystal panels, and each color image may be emitted by modulating the white light emitted from the light source 21 in each liquid crystal panel.

The light from the light source 21 and the optical modulation portion 22 is incident on the projection optical system 23. The projection optical system 23 includes at least one lens and is composed of, for example, a relay optical system. The light that has passed through the projection optical system 23 is projected onto the projection object 6.

In the projection object 6, a region irradiated with the light transmitted through the entire range of the optical modulation portion 22 is the projectable range in which the projection can be performed by the projection portion 1. Within this projectable range, a region irradiated with the light actually transmitted through the optical modulation portion 22 is the projection surface 11. For example, in the projectable range, a size, a position, and a shape of the projection surface 11 are changed by controlling a size, a position, and a shape of a region through which the light is transmitted in the optical modulation portion 22.

The control circuit 24 controls the light source 21, the optical modulation portion 22, and the projection optical system 23 based on the display data input from the control device 4, thereby projecting an image based on this display data onto the projection object 6. The display data input to the control circuit 24 is composed of three pieces of data including red display data, blue display data, and green display data.

In addition, the control circuit 24 changes the projection optical system 23 based on an instruction input from the control device 4, thereby enlarging or reducing the projection surface 11 (see FIG. 1) of the projection portion 1. In addition, the control device 4 may move the projection surface 11 of the projection portion 1 by changing the projection optical system 23 based on the operation received by the operation reception portion 2 from the user.

The projection apparatus 10 also comprises a shift mechanism that mechanically or optically moves the projection surface 11 while maintaining an image circle of the projection optical system 23. The image circle of the projection optical system 23 is a region where the projection light incident on the projection optical system 23 appropriately passes through the projection optical system 23 in terms of a light fall-off, color separation, edge part curvature, or the like.

The shift mechanism is implemented by at least any of an optical system shift mechanism that performs optical system shifting or an electronic shift mechanism that performs electronic shifting

The optical system shift mechanism is, for example, a mechanism (for example, see FIGS. 3 and 4) that moves the projection optical system 23 in a direction perpendicular to an optical axis or a mechanism that moves the optical modulation portion 22 in the direction perpendicular to the optical axis instead of moving the projection optical system 23. Furthermore, the optical system shift mechanism may perform the movement of the projection optical system 23 and the movement of the optical modulation portion 22 in combination with each other.

The electronic shift mechanism is a mechanism that performs pseudo shifting of the projection surface 11 by changing a range through which the light is transmitted in the optical modulation portion 22.

The projection apparatus 10 may also comprise a projection direction changing mechanism that moves the image circle of the projection optical system 23 and the projection surface 11. The projection direction changing mechanism is a mechanism that changes a projection direction of the projection portion 1 by changing the orientation of the projection portion 1 through mechanical rotation (for example, see FIGS. 3 and 4).

### Mechanical Configuration of Projection Apparatus 10

FIG. 3 is a schematic diagram showing an external configuration of the projection apparatus 10. FIG. 4 is a schematic cross-sectional view of an optical unit 106 of the projection apparatus 10 shown in FIG. 3. FIG. 4 shows a cross section in a plane along an optical path of light emitted from a body part 101 shown in FIG. 3.

As shown in FIG. 3, the projection apparatus 10 comprises the body part 101 and the optical unit 106 that is provided to protrude from the body part 101. In the configuration shown in FIG. 3, the operation reception portion 2, the control device 4, and the light source 21, the optical modulation portion 22, and the control circuit 24 in the projection portion 1 are provided in the body part 101. The projection optical system 23 in the projection portion 1 is provided in the optical unit 106.

The optical unit 106 comprises a first member 102 supported by the body part 101 and a second member 103 supported by the first member 102.

The first member 102 and the second member 103 may be an integrated member. The optical unit 106 may be configured to be attachable to and detachable from the body part 101 (in other words, configured to be interchangeable).

The body part 101 includes a housing 15 (see FIG. 4) in which an opening 15a (see FIG. 4) for passing light is formed in a part connected to the optical unit 106.

As shown in FIG. 3, the light source 21 and an optical modulation unit 12 including the optical modulation portion 22 (see FIG. 2) that generates an image by spatially modulating the light emitted from the light source 21 based on input image data are provided inside the housing 15 of the body part 101.

The light emitted from the light source 21 is incident on the optical modulation portion 22 of the optical modulation unit 12 and is spatially modulated and emitted by the optical modulation portion 22.

As shown in FIG. 4, the image formed by the light spatially modulated by the optical modulation unit 12 is incident on the optical unit 106 by passing through the opening 15a of the housing 15 and is projected onto the projection object 6 as a projection target object. Accordingly, an image G1 is visible from an observer.

As shown in FIG. 4, the optical unit 106 comprises the first member 102 including a hollow portion 2A connected to the inside of the body part 101, the second member 103 including a hollow portion 3A connected to the hollow portion 2A, a first optical system 121 and a reflective member 122 disposed in the hollow portion 2A, a second optical system 31, a reflective member 32, a third optical system 33, and a lens 34 disposed in the hollow portion 3A, a shift mechanism 105, and a projection direction changing mechanism 104.

The first member 102 is a member having, for example, a rectangular cross-sectional outer shape, in which an opening 2a and an opening 2b are formed in surfaces perpendicular to each other. The first member 102 is supported by the body part 101 in a state in which the opening 2a is disposed at a position facing the opening 15a of the body part 101. The light emitted from the optical modulation portion 22 of the optical modulation unit 12 of the body part 101 is incident into the hollow portion 2A of the first member 102 through the opening 15a and the opening 2a.

The incidence direction of the light incident into the hollow portion 2A from the body part 101 will be referred to as a direction X1, the direction opposite to the direction X1 will be referred to as a direction X2, and the direction X1 and the direction X2 will be collectively referred to as a direction X. In FIG. 4, the direction from the front to the back of the page and the opposite direction thereto will be referred to as a direction Z. In the direction Z, the direction from the front to the back of the page will be referred to as a direction Z1, and the direction from the back to the front of the page will be referred to as a direction Z2.

In addition, the direction perpendicular to the direction X and to the direction Z will be referred to as a direction Y. In the direction Y, the upward direction in FIG. 4 will be referred to as a direction Y1, and the downward direction in FIG. 4 will be referred to as a direction Y2. In the example in FIG. 4, the projection apparatus 10 is disposed such that the direction Y2 is the vertical direction.

The projection optical system 23 shown in FIG. 2 is composed of the first optical system 121, the reflective member 122, the second optical system 31, the reflective member 32, the third optical system 33, and the lens 34. An optical axis K of the projection optical system 23 is shown in FIG. 4. The first optical system 121, the reflective member 122, the second optical system 31, the reflective member 32, the third optical system 33, and the lens 34 are disposed in this order from the optical modulation portion 22 side along the optical axis K.

The first optical system 121 includes at least one lens and guides the light that is incident on the first member 102 from the body part 101 and travels in the direction X1 to the reflective member 122.

The reflective member 122 reflects the light incident from the first optical system 121 in the direction Y1. The reflective member 122 is composed of, for example, a mirror. In the first member 102, the opening 2b is formed on the optical path of light reflected by the reflective member 122, and the reflected light travels to the hollow portion 3A of the second member 103 by passing through the opening 2b.

The second member 103 is a member having an approximately T-shaped cross-sectional outer shape, in which an opening 3a is formed at a position facing the opening 2b of the first member 102. The light that has passed through the opening 2b of the first member 102 from the body part 101 is incident into the hollow portion 3A of the second member 103 through the opening 3a. The first member 102 and the second member 103 may have any cross-sectional outer shape and are not limited to the above.

The second optical system 31 includes at least one lens and guides the light incident from the first member 102 to the reflective member 32.

The reflective member 32 reflects the light incident from the second optical system 31 in the direction X2 and guides the light to the third optical system 33. The reflective member 32 is composed of, for example, a mirror.

The third optical system 33 includes at least one lens and guides the light reflected by the reflective member 32 to the lens 34.

The lens 34 is disposed at an end part of the second member 103 on the direction X2 side in a form of closing the opening 3c formed at this end part. The lens 34 projects the light incident from the third optical system 33 onto the projection object 6.

The projection direction changing mechanism 104 is a rotation mechanism that rotatably connects the second member 103 to the first member 102. By the projection direction changing mechanism 104, the second member 103 is configured to be rotatable about a rotation axis (specifically, the optical axis K) that extends in the direction Y. The projection direction changing mechanism 104 is not limited to the disposition position shown in FIG. 4 as long as the projection direction changing mechanism 104 can rotate the optical system. Furthermore, the number of rotation mechanisms is not limited to one, and a plurality of rotation mechanisms may be provided. For example, in the configuration of FIG. 3, a rotation mechanism that rotatably connects the first member 102 to the body part 101 may be provided. By means of the rotation mechanism, the first member 102 is configured to be rotatable about a rotation axis that extends in the direction X.

The shift mechanism 105 is a mechanism for moving the optical axis K of the projection optical system (in other words, the optical unit 106) in a direction (direction Y in FIG. 4) perpendicular to the optical axis K. Specifically, the shift mechanism 105 is configured to be able to change a position of the first member 102 in the direction Y with respect to the body part 101. The shift mechanism 105 may manually move the first member 102 or electrically move the first member 102.

FIG. 4 shows a state in which the first member 102 is moved as far as possible to the direction Y1 side by the shift mechanism 105. By moving the first member 102 in the direction Y2 by the shift mechanism 105 from the state shown in FIG. 4, the relative position between the center of the image (in other words, the center of the display surface) formed by the optical modulation portion 22 and the optical axis K changes, and the image G1 projected onto the projection object 6 can be shifted (translated) in the direction Y2.

The shift mechanism 105 may be a mechanism that moves the optical modulation portion 22 in the direction Y instead of moving the optical unit 106 in the direction Y. Even in this case, the image G1 projected onto the projection object 6 can be moved in the direction Y2.

### Appearance of Information Processing Terminal 50

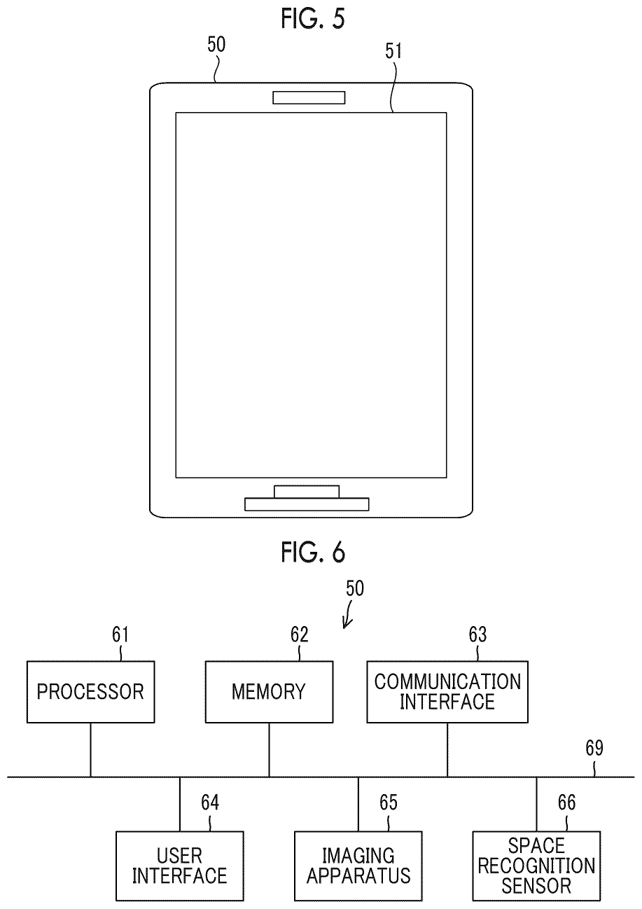

FIG. 5 is a diagram showing an example of an appearance of an information processing terminal 50. The information processing terminal 50 is a tablet terminal having a touch panel 51. The touch panel 51 is a display that allows a touch operation. The information processing terminal 50 displays, on the touch panel 51, an installation support image for supporting installation of the projection apparatus 10 in a space.

Specifically, the information processing terminal 50 displays, as an installation support image, a second image in which an image of a virtual projection surface, which is a virtual projection surface 11, and an image of a virtual projection apparatus, which is a virtual projection apparatus 10, are superimposed on a first image obtained by imaging the space in which the projection apparatus 10 is installed and performs the projection.

### Hardware Configuration of Information Processing Terminal 50

FIG. 6 is a diagram showing an example of a hardware configuration of the information processing terminal 50. For example, as shown in FIG. 6, the information processing terminal 50 shown in FIG. 5 comprises a processor 61, a memory 62, a communication interface 63, a user interface 64, an imaging apparatus 65, and a space recognition sensor 66. The processor 61, the memory 62, the communication interface 63, the user interface 64, the imaging apparatus 65, and the space recognition sensor 66 are connected by, for example, a bus 69.

The processor 61 is a circuit that performs signal processing, and is, for example, a CPU that controls the entire information processing terminal 50. The processor 61 may be implemented by other digital circuits such as an FPGA and a digital signal processor (DSP). The processor 61 may also be implemented by combining a plurality of digital circuits.

For example, the memory 62 includes a main memory and an auxiliary memory. For example, the main memory is a random-access memory (RAM). The main memory is used as a work area of the processor 61.

The auxiliary memory is, for example, a non-volatile memory such as a magnetic disk or a flash memory. The auxiliary memory stores various programs for operating the information processing terminal 50. The programs stored in the auxiliary memory are loaded into the main memory and executed by the processor 61.

In addition, the auxiliary memory may include a portable memory that can be detached from the information processing terminal 50. Examples of the portable memory include a memory card such as a universal serial bus (USB) flash drive or a secure digital (SD) memory card, and an external hard disk drive.

The communication interface 63 is a communication interface for communicating with apparatuses outside the information processing terminal 50. The communication interface 63 includes at least any of a wired communication interface for performing wired communication or a wireless communication interface for performing wireless communication. The communication interface 63 is controlled by the processor 61.

The user interface 64 includes, for example, an input device that receives an operation input from the user, and an output device that outputs information to the user. The input device can be implemented by, for example, a key (for example, a keyboard) or a remote controller. The output device can be implemented by, for example, a display or a speaker. In the information processing terminal 50 shown in FIG. 5, the input device and the output device are implemented by the touch panel 51. The user interface 64 is controlled by the processor 61. The information processing terminal 50 receives various types of designation from the user using the user interface 64.

The imaging apparatus 65 is an apparatus that has an imaging optical system and an imaging element and that can perform imaging. The imaging apparatus 65 includes, for example, an imaging apparatus provided on a back surface (surface opposite to a surface on which the touch panel 51 is provided) of the information processing terminal 50 shown in FIG. 5.

The space recognition sensor 66 is a sensor that can three-dimensionally recognize a space around the information processing terminal 50. The space recognition sensor 66 is, as an example, a light detection and ranging (LiDAR) sensor of performing irradiation with laser light, measuring a time taken until the laser light of irradiation hits an object and reflects back, and measuring a distance and a direction to the object. However, the space recognition sensor 66 is not limited thereto and can be various sensors such as a radar that emits radio waves, and an ultrasonic sensor that emits ultrasound waves.

### System of Embodiment

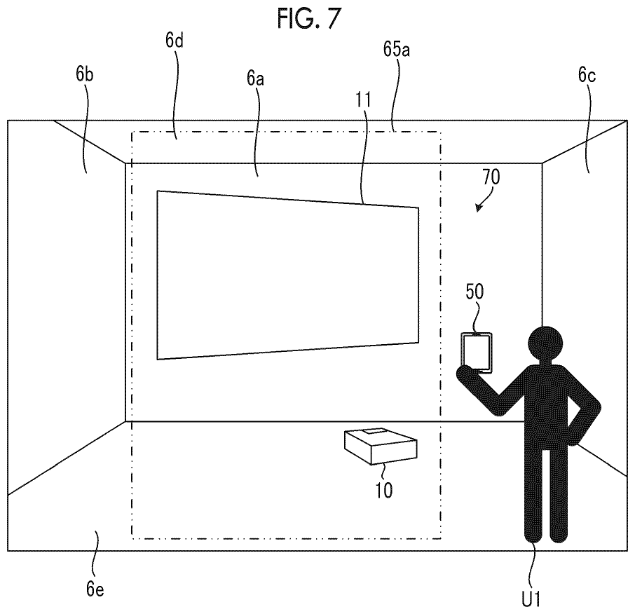

FIG. 7 is a diagram showing an example of a system of the embodiment. As shown in FIG. 7, for example, a user U1 of the information processing terminal 50 brings a system including the information processing terminal 50 and the projection apparatus 10 into a physical space 70 where projection apparatus 10 is to be installed. In this case, the information processing terminal 50 is an example of an image processing apparatus in the system according to the embodiment of the present invention.

The information processing terminal 50 recognizes the physical space 70 by the space recognition sensor 66. Specifically, the information processing terminal 50 recognizes the physical space 70 by a world coordinate system including an X-axis, a Y-axis, and a Z-axis, in which the X-axis is one horizontal direction in the physical space 70, the Y-axis is a direction of gravitational force in the physical space 70, and the Z-axis is a direction orthogonal to the X-axis and to the Y-axis in the physical space 70.

Further, the information processing terminal 50 displays a captured image based on imaging data obtained by imaging using the imaging apparatus 65 on the touch panel 51 as a through-image (live view) to the user. The imaging data is an example of the first image data. The captured image is an example of the first image.

In the example of FIG. 7, the physical space 70 is indoors, and a wall 6a is the projection target object. It is assumed that upper, lower, left, and right sides of the wall 6a in FIG. 7 are upper, lower, left, and right sides in the present embodiment. A wall 6b is a wall adjacent to the left end of the wall 6a and perpendicular to the wall 6a. A wall 6c is a wall adjacent to a right end of the wall 6a and perpendicular to the wall 6a. A ceiling 6d is a ceiling adjacent to an upper end of the wall 6a and perpendicular to the wall 6a. A floor 6e is a floor adjacent to a lower end of the wall 6a and perpendicular to the wall 6a.

In the example of FIG. 7, the projection apparatus 10 is installed on the floor 6e, but the projection apparatus 10 may be installed on a pedestal or the like installed on the floor 6e, or may be installed on the walls 6b and 6c, or the ceiling 6d by using an attachment tool. An imaging range 65a is a range of imaging with the imaging apparatus 65 of the information processing terminal 50.

The user U1 adjusts the position and the direction of the information processing terminal 50 and the angle of view of the information processing terminal 50 such that the projection apparatus 10 and the projection surface 11 are included in the imaging range 65a (that is, are displayed on the touch panel 51) while viewing the through-image (second image) displayed on the touch panel 51 of the information processing terminal 50.

In the example of FIG. 7, the imaging range 65a includes the wall 6a, the ceiling 6d, the floor 6e, the projection apparatus 10, and the projection surface 11. In addition, in the example of FIG. 7, the projection surface 11 is a trapezoid because the projection apparatus 10 is obliquely installed with respect to the wall 6a which is the projection target object. In addition, in the example of FIG. 7, the user U1 holds the information processing terminal 50 by hand, but the information processing terminal 50 may be supported by a support member such as a tripod.

### Display of Second Image With Information Processing Terminal 50

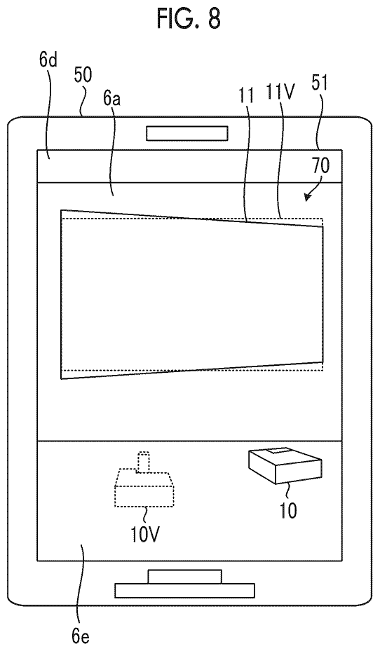

FIG. 8 is a diagram showing an example of display of a second image with the information processing terminal 50. In the state shown in FIG. 7, as shown in FIG. 8, the information processing terminal 50 displays the second image in which a virtual projection apparatus 10V and a virtual projection surface 11V are superimposed on the captured image (first image) obtained by imaging.

For example, the information processing terminal 50 stores virtual projection apparatus data related to the virtual projection apparatus 10V and virtual projection surface data related to the virtual projection surface 11V. The virtual projection apparatus data is data representing a position, a direction, and the like of the virtual projection apparatus 10V in a virtual space corresponding to the physical space 70. The virtual projection surface data is data representing a position, a direction, and the like of the virtual projection surface 11V in the virtual space corresponding to the physical space 70. The virtual projection apparatus data and the virtual projection surface data are generated by, for example, a preliminary simulation related to the installation of the projection apparatus 10 in the physical space 70.

The information processing terminal 50 generates and displays the second image by superimposing the virtual projection apparatus 10V and the virtual projection surface 11V on the captured image (first image) based on the recognition result of the physical space 70 via the space recognition sensor 66, the virtual projection apparatus data, and the virtual projection surface data.

### Adjustment of Projection State of Projection Apparatus 10 Based on Display of Second Image

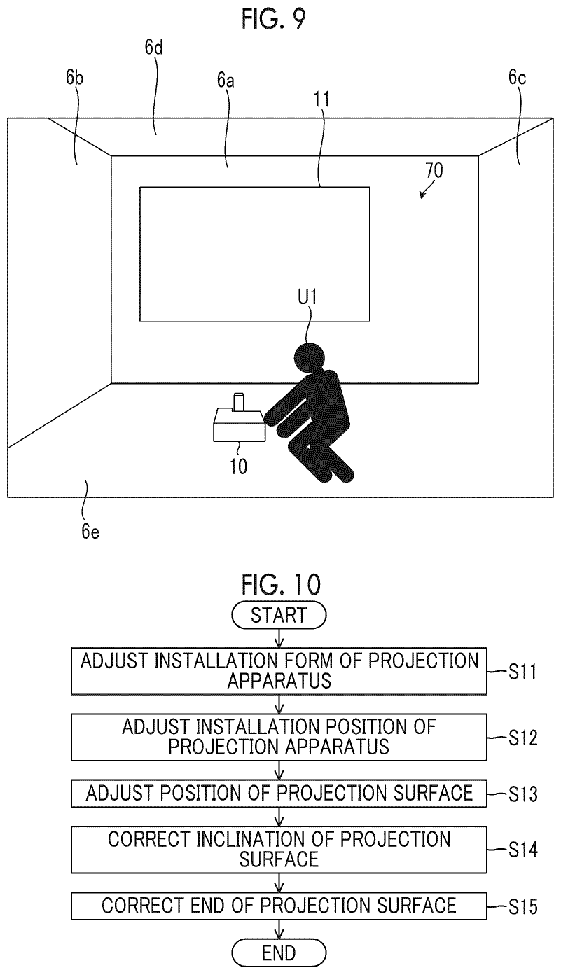

FIG. 9 is a diagram showing an example of adjustment of a projection state of the projection apparatus 10 based on the display of the second image. As shown in FIG. 8, the second image in which the virtual projection apparatus 10V and the virtual projection surface 11V are superimposed on the captured image (first image) is displayed. Accordingly, the operator (for example, the user U1) in the projection state of the projection apparatus 10 can easily compare the state of the projection apparatus 10 and the projection surface 11 in the current physical space 70 with the virtual projection apparatus 10V and the virtual projection surface 11V based on the preliminary simulation related to the installation of the projection apparatus 10 in the physical space 70.

Based on this, as shown in FIG. 9, the operator adjusts the position and the direction of the projection apparatus 10 in the physical space 70, various settings of the projection apparatus 10, and the like to be close to the preliminary simulation results. In this case, in a case where the state of the projection apparatus 10 and the projection surface 11 is reproduced as in the simulation result, there are the following problems.

First, the simulation result includes an error or an incorrect value, and even in a case where the simulation result is applied as it is to reality, a result as expected may not be obtained. In addition, it is practically difficult to place the projection apparatus 10, which is the actual apparatus, at a position that is exactly the same as the simulation result, and therefore, the projection surface 11 may deviate from the simulation result, and a result as expected may not be obtained. In particular, in a case where the angle of view of the projection apparatus 10 is wide, the deviation of the projection surface 11 is also large. In addition, in a case where it is desired to reproduce the projection of the actual object before the construction of the projection apparatus 10 for the simulation result such as installation on the ceiling 6d (hanging from a ceiling) or installation on a virtual pedestal that does not yet exist, it may be physically difficult to place the projection apparatus 10 at the position as in the simulation, and the simulation result may not be able to be used as it is.

On the other hand, the information processing terminal 50 of the present embodiment generates the assist information for bringing the projection state via the projection apparatus 10 close to the projection state represented by the simulation result and outputs the assist information to the operator, thereby efficiently adjusting the projection state via the projection apparatus 10 to be close to the simulation result. The projection state via the projection apparatus 10 includes at least one of a state related to projection of the projection apparatus 10 itself or a state of the projection surface 11 via the projection apparatus 10.

### Adjustment of Projection State of Projection Apparatus 10

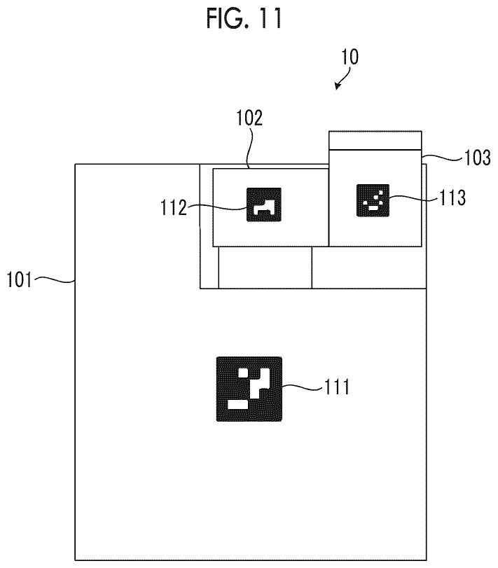

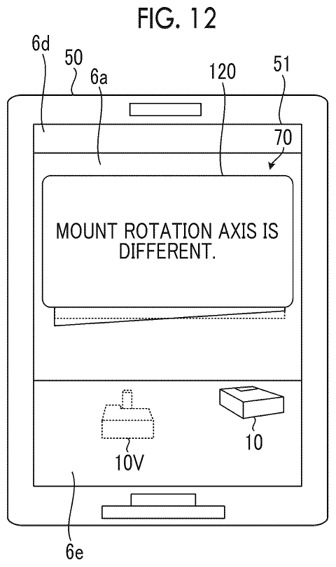

FIG. 10 is a flowchart showing an example of the adjustment of the projection state of the projection apparatus 10. First, the installation form of the projection apparatus 10 is adjusted (step S11). The installation form of the projection apparatus 10 is a setting condition of the projection apparatus 10 itself, such as an installation style (for example, “vertical placement” or “horizontal placement”), a ground surface (for example, “floor” or “ceiling”), a mount axis rotation (for example, a state of a rotation mechanism that rotatably connects the first member 102 with respect to the body part 101), and a lens axis rotation (for example, a state of the projection direction changing mechanism 104) of the projection apparatus 10. The adjustment of the installation form of the projection apparatus 10 in step S11 will be described later (for example, refer to FIGS. 11, 12, and the like).

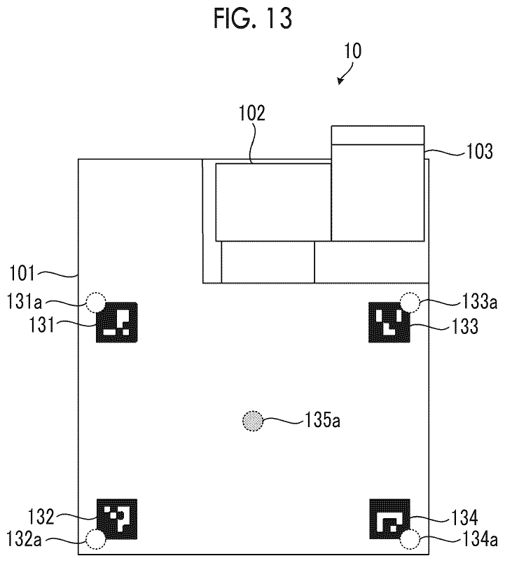

Next, the installation position of the projection apparatus 10 is adjusted (step S12). The adjustment of the installation position of the projection apparatus 10 in step S12 will be described later (for example, see FIGS. 13 to 22, and the like). Next, the position of the projection surface 11 of the projection apparatus 10 is adjusted (step S13). The adjustment of the position of the projection surface 11 of the projection apparatus 10 in step S13 will be described later.

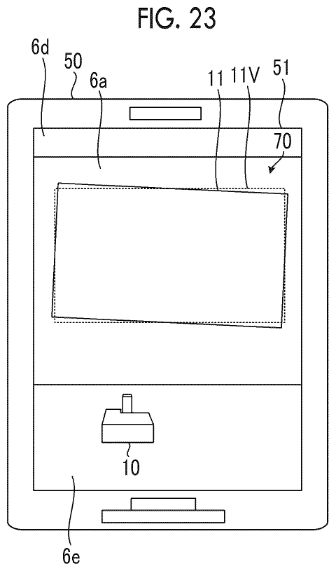

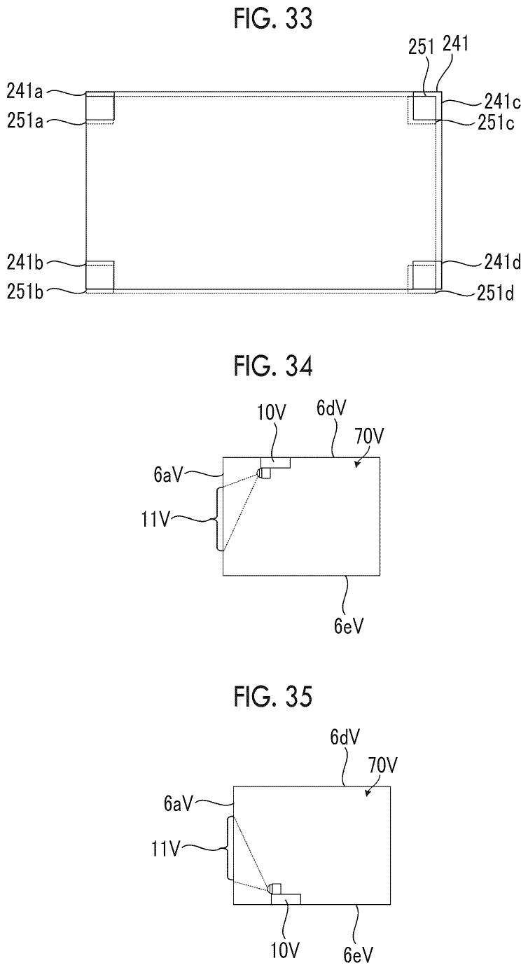

Next, the inclination of the projection surface 11 of the projection apparatus 10 is corrected (step S14). The correction of the inclination of the projection surface 11 of the projection apparatus 10 in step S14 will be described later (for example, see FIGS. 23 to 32, and the like). Next, the end of the projection surface 11 of the projection apparatus 10 is corrected (step S15). The correction of the end of the projection surface 11 of the projection apparatus 10 in step S15 will be described later (for example, see FIG. 33, and the like).

### Adjustment of Installation Form of Projection Apparatus 10

FIG. 11 is a diagram showing an example of a marker for adjusting an installation form of the projection apparatus 10. For example, in the projection apparatus 10, it is assumed that the first member 102 is rotatable with respect to the body part 101 and the second member 103 is movable rotationally with respect to the first member 102. In this case, markers 111 to 113 are attached to the body part 101, the first member 102, and the second member 103, respectively. The markers 111 to 113 are markers having different shapes. In addition, markers may be attached to portions of the first member 102 and the second member 103 that are not shown in FIG. 11.

Accordingly, in step S11 shown in FIG. 10, the information processing terminal 50 can specify the installation form of the projection apparatus 10, such as the rotation state of the first member 102 with respect to the body part 101 (mount axis rotation) or the rotation state of the second member 103 with respect to the first member 102 (lens axis rotation), by detecting which marker is reflected and which direction the marker that is reflected is directed, based on the imaging data obtained by imaging with the imaging apparatus 65 in a state in which the projection apparatus 10 is included in the imaging range 65a.

In addition, the information processing terminal 50 can specify the installation form of the projection apparatus 10, such as whether the projection apparatus 10 is in the installation style of “vertical placement” or “horizontal placement” or whether the projection apparatus 10 is installed on a ground surface of “floor” or “ceiling”, based on the imaging data obtained by imaging with the imaging apparatus 65 in a state in which the projection apparatus 10 is included in the imaging range 65a. In this case, the information processing terminal 50 may specify the installation form of the projection apparatus 10, such as the installation style and the ground surface, by using the detection result of the marker of the projection apparatus 10.

FIG. 12 is a diagram showing an example of display for prompting a change of a mount rotation axis. As a result of specifying the installation form of the projection apparatus 10, it is assumed that the mount rotation axis of the projection apparatus 10 is different from the simulation result (virtual projection apparatus data).

In this case, the information processing terminal 50 displays a message 120 of “Mount rotation axis is different.” via the touch panel 51 in step S11 shown in FIG. 10. The message 120 is an example of assist information for bringing the projection state via the projection apparatus 10 close to the projection state represented by the simulation result.

With the message 120, the operator can easily recognize that the mount rotation axis of the projection apparatus 10 is different from the simulation result, and can adjust the mount rotation axis of the projection apparatus 10 to be substantially the same as the simulation result. In addition, the information processing terminal 50 may display, as the assist information, guide information for guiding a method of adjusting the mount rotation axis of the projection apparatus 10, and the like, together with the message 120.

In addition, the information processing terminal 50 may output a message of “Mount rotation axis is different.” or guide information via voice in addition to or instead of the screen display. The output via the voice can be performed by, for example, a speaker included in the user interface 64.

In the example of FIG. 12, a case where the mount rotation axis of the projection apparatus 10 is different from the simulation result among the installation forms of the projection apparatus 10 has been described. However, similarly, in a case where other installation forms such as the installation style, the ground surface, and the lens axis rotation of the projection apparatus 10 are different from the simulation results, the information processing terminal 50 generates and outputs the assist information.

While a configuration in which the installation form of the projection apparatus 10 is specified by using the markers (for example, the markers 111 to 113) attached to the projection apparatus 10 has been described, the present invention is not limited to such a configuration. For example, the information processing terminal 50 may specify the installation form of the projection apparatus 10 based on the imaging data obtained by imaging with the imaging apparatus 65 in a state in which the projection apparatus 10 is included in the imaging range 65a, using a learning model generated by machine learning using images of respective installation forms of the same type of projection apparatus as the projection apparatus 10. In this case, the marker does not need to be attached to the projection apparatus 10.

### Adjustment of Installation Position of Projection Apparatus 10

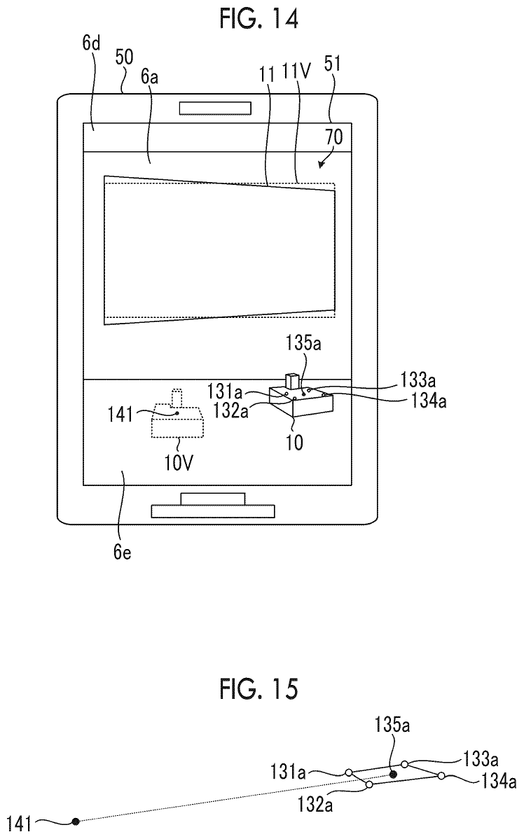

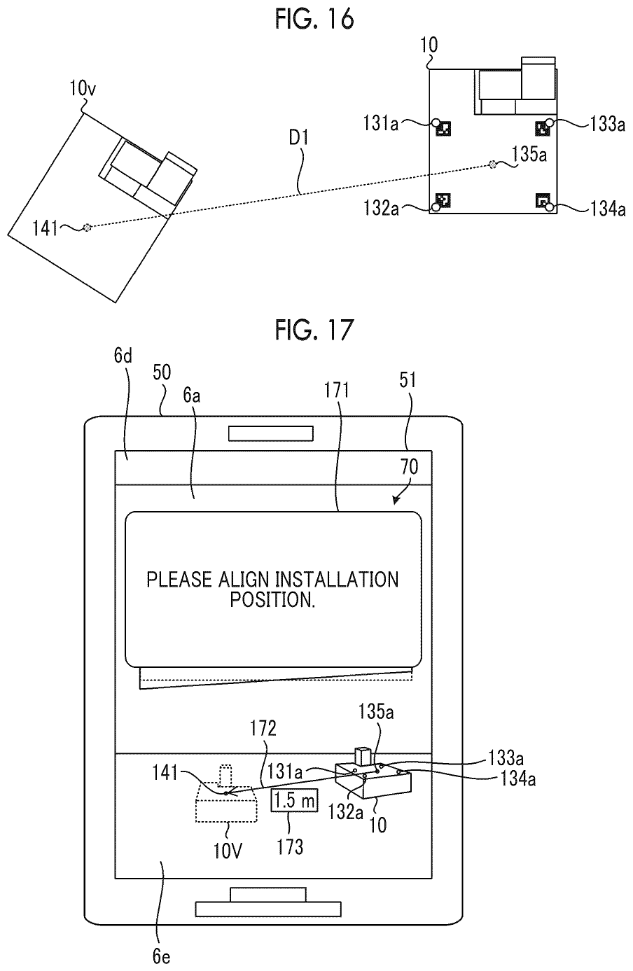

FIG. 13 is a diagram showing an example of a marker for adjusting an installation position of the projection apparatus 10. FIG. 14 is a diagram showing an example of detection of a position of the projection apparatus 10 based on a marker. FIG. 15 is a diagram showing each point recognized by the information processing terminal 50 in a camera coordinate system of FIG. 14. FIG. 16 is a diagram showing each point recognized by the information processing terminal 50 in a plane of a rear surface of the projection apparatus 10. Here, it is assumed that the projection apparatus 10 is placed on substantially the same plane (floor 6e) as the virtual projection apparatus 10V in the physical space 70 by step S11 shown in FIG. 10.

For example, markers 131 to 134 are attached to different positions on a rear surface (in this example, a surface that is an upper surface) of the body part 101 of the projection apparatus 10. Accordingly, in step S12 shown in FIG. 10, the information processing terminal 50 can specify the current installation position of the projection apparatus 10 in the physical space 70 by detecting the respective positions of the markers 131 to 134 based on the imaging data obtained by imaging with the imaging apparatus 65 in a state in which the projection apparatus 10 is included in the imaging range 65a.

For example, the markers 131 to 134 are disposed on a circumference centered at a predetermined reference point 135a on the rear surface of the body part 101, and the information processing terminal 50 detects the positions of the markers 131 to 134. Points 131a, 132a, 133a, and 134a are four corners of a quadrangle in which the markers 131 to 134 are inscribed at the four corners.

The information processing terminal 50 specifies the position of the reference point 135a of the projection apparatus 10 as the installation position of the projection apparatus 10 based on the detection result of the positions of the markers 131 to 134. A reference point 141 is a reference point of the virtual projection apparatus 10V, corresponding to the reference point 135a of the projection apparatus 10. The reference points 135a and 141 are positions offset from the floor 6e on which the projection apparatus 10 (virtual projection apparatus 10V) is installed by the height of the projection apparatus 10 (virtual projection apparatus 10V).

In general, in a case where the position of each of the four points between the planes is known, the mapping (projective transformation) between the planes can be performed for any point. The points 131a, 132a, 133a, and 134a and the reference point 135a in FIG. 15 are obtained from the detection results of the markers 131 to 134 in the camera coordinates. Meanwhile, the points 131a, 132a, 133a, and 134a and the reference point 135a in FIG. 16 are known positions at which the markers 131 to 134 are attached in the projection apparatus 10.

Accordingly, the information processing terminal 50 can obtain a projective transformation matrix (homography matrix) from the camera plane of FIG. 15 to the plane of the rear surface of the projection apparatus 10. The information processing terminal 50 maps the reference point 141 of FIG. 15 onto the plane of FIG. 16 based on the projective transformation matrix to obtain the center position (reference point 141) of the virtual projection apparatus 10V in the plane of FIG. 16.

In addition, since the sizes of the markers 131 to 134, the width of the body part 101 of the projection apparatus 10, and the like in the plane of FIG. 16 are known, the information processing terminal 50 calculates a distance DI between the reference point 141 and the reference point 135a in FIG. 16 from the ratio of the sizes and the width.

In FIG. 13, an example in which the markers 131 to 134 different from the markers 111 to 113 for adjusting the installation form of the projection apparatus 10 shown in FIG. 11 are attached to the projection apparatus 10 in order to adjust the installation position of the projection apparatus 10 has been described. However, both the markers 111 to 113 for adjusting the installation form of the projection apparatus 10 and the markers 131 to 134 for adjusting the installation position of the projection apparatus 10 may be attached to the projection apparatus 10. In addition, both the adjustment of the installation form of the projection apparatus 10 and the adjustment of the installation position of the projection apparatus 10 may be performed using a common marker attached to the projection apparatus 10.

FIG. 17 is a diagram showing an example of display for prompting the adjustment of the installation position of the projection apparatus 10. As in the examples of FIGS. 15 and 16, it is assumed that the position of the projection apparatus 10 (position of the reference point 135a) is different from the simulation result (virtual projection apparatus data).

In this case, the information processing terminal 50 displays a message 171 of “Please align installation position.” via the touch panel 51 in step S12 shown in FIG. 10. The message 171 is an example of assist information for bringing the projection state via the projection apparatus 10 close to the projection state represented by the simulation result.

With the message 171, the operator can easily recognize that the installation position of the projection apparatus 10 is different from the simulation result, and can adjust the installation position of the projection apparatus 10 to be substantially the same as the simulation result.

In addition, the information processing terminal 50 may display, as the assist information, guide information for guiding a method of adjusting the installation position of the projection apparatus 10, and the like, in addition to or instead of the message 171. For example, the information processing terminal 50 may display an arrow pointing from the reference point 135a to the reference point 141 as movement direction information 172 for guiding the movement direction of the projection apparatus 10. In addition, the information processing terminal 50 may display distance information such as “1.5 m” as moving distance information 173 for guiding the moving distance (for example, the distance D1) of the projection apparatus 10.

In addition, the information processing terminal 50 may output the message 171 of “Please align installation position.” or guide information via voice in addition to or instead of the screen display. The output via the voice can be performed by, for example, a speaker included in the user interface 64. The display image via the touch panel 51 shown in FIG. 17 is an example of a third image in which the assist information is displayed on the second image.

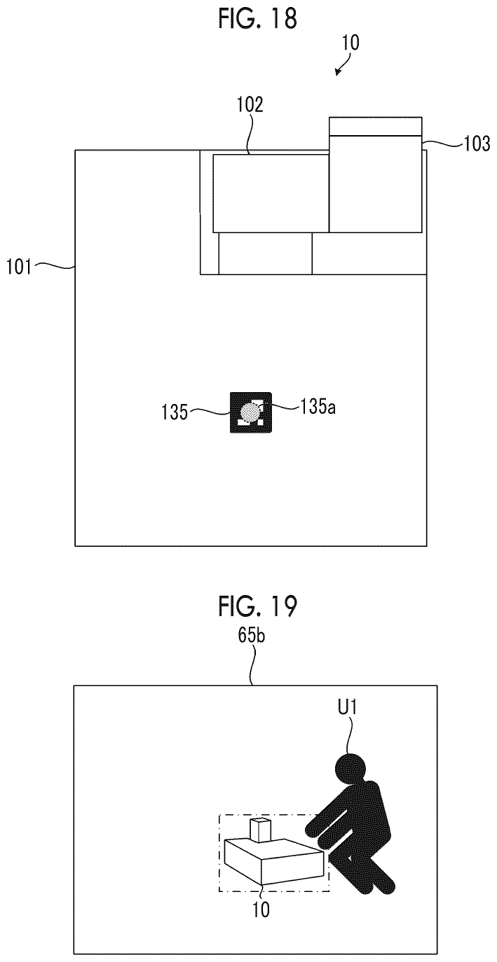

FIG. 18 is a diagram showing another example of the marker for adjusting the installation position of the projection apparatus 10. For example, instead of the markers 131 to 134 shown in FIG. 13 and the like, a marker 135 shown in FIG. 18 may be attached to the rear surface (in this example, a surface that is an upper surface) of the body part 101 of the projection apparatus 10. The marker 135 is attached such that, for example, the reference point 135a of the projection apparatus 10 and the center of the marker 135 match each other.

In this case, in step S12 shown in FIG. 10, the information processing terminal 50 can specify the installation position of the projection apparatus 10 in the physical space 70 by detecting the position of the marker 135 (position of the reference point 135a) based on the imaging data obtained by imaging with the imaging apparatus 65 in a state in which the projection apparatus 10 is included in the imaging range 65a.

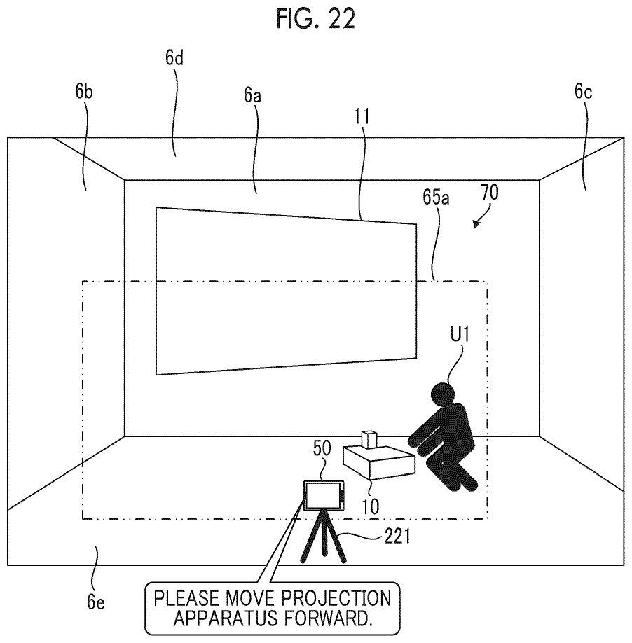

FIGS. 19 and 22 are diagrams showing an example of output of assist information based on a recognition result of an operator who installs the projection apparatus 10. In the examples of FIGS. 19 to 22, imaging is performed by the imaging apparatus 65 in a state in which the projection apparatus 10 (imaging apparatus 65) is fixed by a tripod 221 (see FIG. 22) such that the projection apparatus 10 and the virtual projection apparatus 10V are within the imaging range 65a.

As shown in FIG. 19, the information processing terminal 50 detects the projection apparatus 10 by performing object detection based on a learning model generated by machine learning using an image of the same type of the projection apparatus as the projection apparatus 10 on a captured image 65b (video frame) represented by the imaging data obtained by imaging with the imaging apparatus 65.

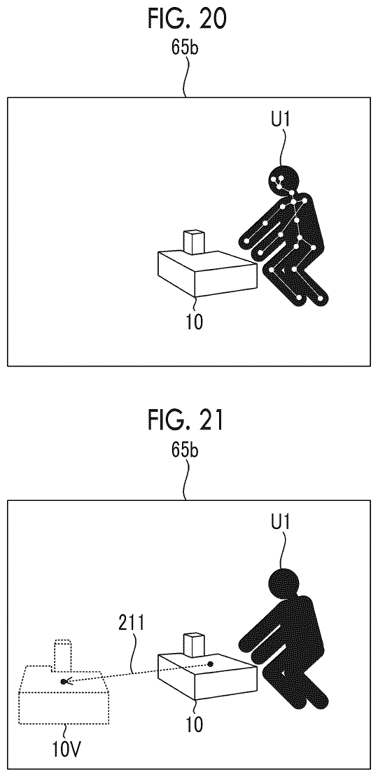

In addition, as shown in FIG. 20, the information processing terminal 50 detects the posture of the operator (for example, the user U1) by performing the person posture detection based on a learning model generated by machine learning using an image of each posture of the person on the captured image 65b.

In addition, as shown in FIG. 21, the information processing terminal 50 calculates a movement direction 211 in which the projection apparatus 10 is to be moved to be at the same position as the virtual projection apparatus 10V. In addition, the information processing terminal 50 calculates which direction the calculated movement direction 211 is as viewed from the operator based on the posture of the operator detected by the person posture detection. In the example of FIG. 21, since the movement direction 211 is generally the left direction and the operator also generally faces the left direction, the movement direction 211 is generally the front side as viewed from the operator.

As shown in FIG. 22, the information processing terminal 50 outputs a message such as “Please move projection apparatus forward.” via voice. The output via the voice can be performed by, for example, a speaker included in the user interface 64. The message is an example of assist information for bringing the projection state via the projection apparatus 10 close to the projection state represented by the simulation result. Accordingly, the operator can easily recognize in which direction the projection apparatus 10 needs to be moved as viewed from the operator.

### Adjustment of Position of Projection Surface 11

Via steps S11 and S12 shown in FIG. 10, the installation form and the installation position of the projection apparatus 10 are in a state almost the same as the simulation results. Therefore, in step S13 shown in FIG. 10, the position of the projection surface 11 can be adjusted by adjusting the projection condition (screen ratio, optical zoom, optical lens shift mode, optical lens shift operation amount, and the like) of the projection apparatus 10.

For example, the information processing terminal 50 outputs projection condition information indicating the projection condition of the projection apparatus 10, such as the screen ratio, the optical zoom, the optical lens shift mode, and the optical lens shift operation amount, included in the simulation result to the user U1 to prompt the user U1 to set the projection condition of the projection apparatus 10 to be the same as the simulation results. The projection condition information in this case is an example of assist information for bringing the projection state via the projection apparatus 10 close to the projection state represented by the simulation result. The output of the projection condition information can be performed by a screen display via the touch panel 51, a voice output via a speaker included in the user interface 64, or the like.

Alternatively, the information processing terminal 50 may perform control of setting the projection condition included in the simulation result to the projection apparatus 10 by communicating with the projection apparatus 10.

Even in a case where the position of the projection surface 11 is adjusted as described here, the plane of the virtual projection surface 11V and the plane of the projection surface 11 may not slightly coincide with each other. This is caused by, for example, a projection deviation due to a slight positional deviation in the adjustment of the installation position of the projection apparatus 10 in step S12 shown in FIG. 10, or an error in the surface detection in the information processing terminal 50. However, here, the plane of the virtual projection surface 11V and the plane of the projection surface 11 are considered to be the same, that is, a slight error is allowed, to adjust the position of the projection surface 11.

### Correction of Inclination of Projection Surface 11

FIG. 23 is a diagram showing an example of an inclination of a projection surface 11. Via step S13 shown in FIG. 10, the position of the projection surface 11 substantially coincides with the virtual projection surface 11V, but as shown in FIG. 23, the projection surface 11 may be inclined with respect to the virtual projection surface 11V, resulting in a deviation. This is caused by the fact that the plane of the virtual projection surface 11V and the plane of the projection surface 11 do not slightly coincide with each other due to the above-described deviation or error, and the like.

The inclination of the projection surface 11 of the projection apparatus 10 can also be corrected by correcting (electronically correcting) the projection image, but the deterioration of the projection image quality is large. Therefore, in step S14 shown in FIG. 10, in order to suppress the deterioration of the projection image quality due to the correction of the projection image, the inclination is corrected as much as possible by readjusting the installation position of the projection apparatus 10, and then the inclination is corrected by the correction of the projection image.

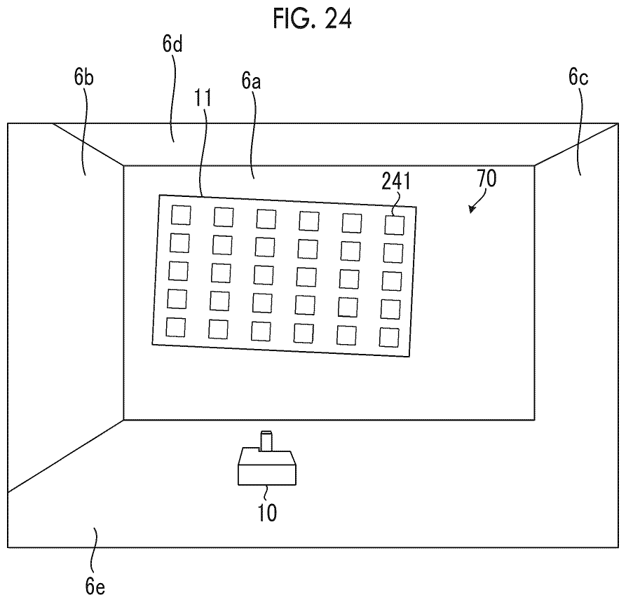

FIG. 24 is a diagram showing an example of a marker grid projected by the projection apparatus 10. The projection apparatus 10 can project, for example, a marker grid 241 for registration on the projection surface 11. The marker grid 241 is obtained by disposing a plurality of markers at intervals. In the example of FIG. 24, the marker grid 241 is obtained by arranging 30 markers in a 5×6 matrix.

The shapes of the markers included in the marker grid 241 are different from each other, and the information processing terminal 50 can specify the position of the detected marker on the projection surface 11 by detecting each marker of the marker grid 241. In the drawing, each marker of the marker grid 241 is shown by a rectangular shape having the same shape. In the example of FIG. 24, the projection surface 11 is inclined as in the example of FIG. 23, and thus the marker grid 241 is also inclined.

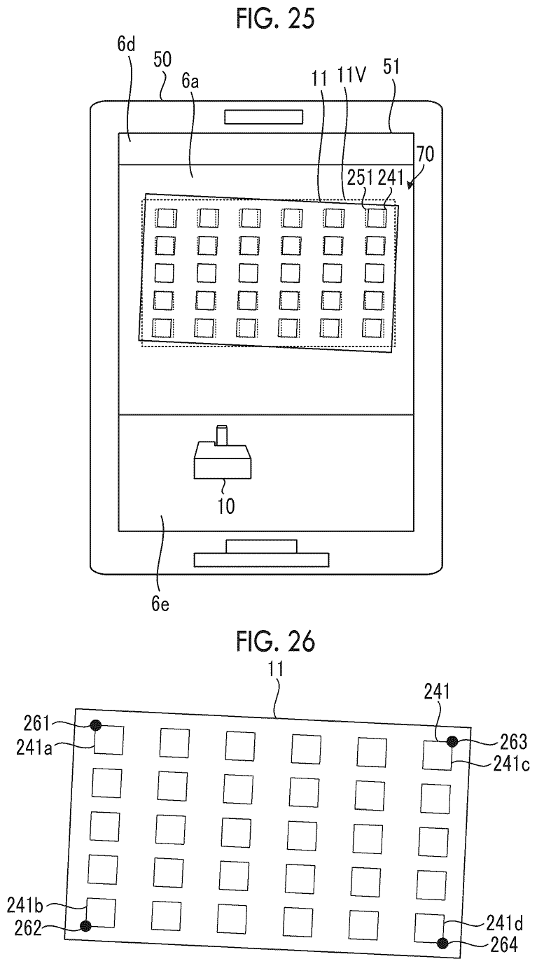

FIG. 25 is a diagram showing an example of a marker grid of a virtual projection surface 11V displayed by the information processing terminal 50. The information processing terminal 50 may further superimpose a marker grid 251 on the second image in which the virtual projection apparatus 10V and the virtual projection surface 11V are superimposed on the captured image (first image). The marker grid 251 virtually shows the marker grid 241. In the example of FIG. 25, the marker grids 241 and 251 also deviate from each other due to the inclination of the projection surface 11 with respect to the virtual projection surface 11V. FIG. 26 shows an example of a marker grid 241 of the projection apparatus 10 in a camera plane of an imaging apparatus 65. Markers 241a to 241d are markers at four corners of the marker grid 241. The information processing terminal 50 detects the markers 241a to 241d included in the captured image 65b and detects corner positions 261 to 264 of the marker grid 241 based on the markers 241a to 241d.

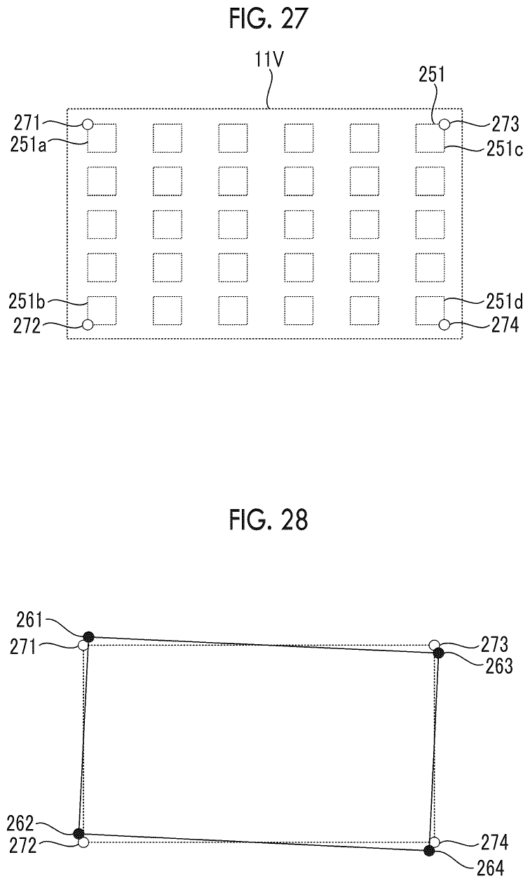

FIG. 27 shows an example of a marker grid 251 of the virtual projection surface 11V in the camera plane of the imaging apparatus 65. Markers 251a to 251d of the marker grid 251 are markers at four corners of the marker grid 251, corresponding to the markers 241a to 241d of the marker grid 241. Corner positions 271 to 274 are corner positions of the marker grid 251, corresponding to the corner positions 261 to 264 of the marker grid 241.

The marker grid 251 shown in FIG. 27 is a marker grid in a case where the imaging apparatus 65 (information processing terminal 50) is completely facing the wall 6a, and the corner positions 271 to 274 are rectangular four corners. However, in a case where the imaging apparatus 65 is oblique with respect to the wall 6a, the corner positions 271 to 274 are trapezoidal four corners.

FIG. 28 shows an example of a quadrangle connecting each point in a case where a plane of the virtual projection surface 11V is set as a reference plane. The information processing terminal 50 calculates a projection matrix for converting the corner positions 271 to 274 shown in FIG. 27 into four positions with the plane of the virtual projection surface 11V as the reference plane. The information processing terminal 50 maps the corner positions 261 to 264 shown in FIG. 26 to four positions in a reference plane (plane of the virtual projection surface 11V) based on the calculated projection matrix, as shown in FIG. 28.

Accordingly, the inclination of the projection surface 11 (corner positions 261 to 264) with respect to the virtual projection surface 11V (corner positions 271 to 274) can be calculated. In the example of FIG. 28, the projection surface 11 is in a state of being rotated about the projection direction of the projection apparatus 10 with respect to the virtual projection surface 11V.

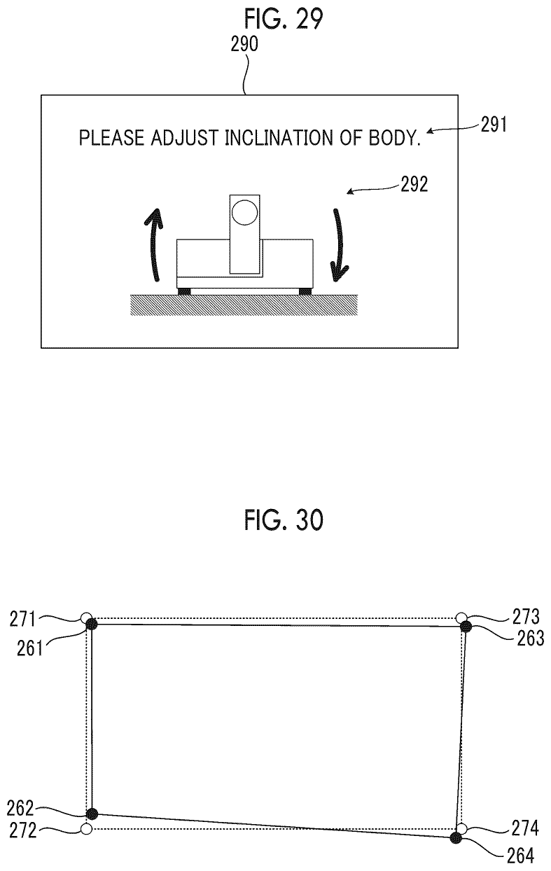

FIG. 29 is a diagram showing an example of display for prompting adjustment of the inclination of the projection surface 11 in the example of FIG. 28. In the example shown in FIG. 28, the information processing terminal 50 displays, via the touch panel 51, a support image 290 including a message 291 of “Please adjust inclination of body.” and a guide image 292 for guiding to adjust the inclination such that the projection apparatus 10 is rotated about the projection direction of the projection apparatus 10, in step S14 shown in FIG. 10. The support image 290 is an example of assist information for bringing the projection state via the projection apparatus 10 close to the projection state represented by the simulation result.

With the support image 290, the operator can easily recognize that the projection apparatus 10 is inclined in the rotation direction about the projection direction of the projection apparatus 10 with respect to the simulation result, and can adjust the inclination of the projection apparatus 10 in the rotation direction about the projection direction of the projection apparatus 10 to be substantially the same as the simulation result.

In addition, the information processing terminal 50 may display, as the assist information, guide information for guiding a method for adjusting the inclination of the projection apparatus 10 in the rotation direction about the projection direction of the projection apparatus 10, and the like. As a method for adjusting the inclination of the projection apparatus 10, for example, there is a method of adjusting the height of the adjustment leg provided on the bottom surface of the projection apparatus 10.

In addition, the information processing terminal 50 may output these types of assist information related to the inclination via voice in addition to or instead of the screen display. The output via the voice can be performed by, for example, a speaker included in the user interface 64.

In addition, the information processing terminal 50 may display the support image 290 shown in FIG. 29 by superimposing the support image 290 on the second image in which the virtual projection apparatus 10V and the virtual projection surface 11V are superimposed on the captured image (first image). The display image via the touch panel 51 in this case is an example of a third image in which the assist information is displayed on the second image.

FIG. 30 shows another example of the quadrangle connecting each point in a case where the plane of the virtual projection surface 11V is set as the reference plane. In the example of FIG. 30, in the plane of the virtual projection surface 11V as a reference plane, a quadrangle having the corner positions 261 to 264 as apexes has a shape in which the side on the right side is longer than the side on the left side. In this case, it can be determined that the projection apparatus 10 is inclined with respect to the wall 6a in a rotation direction about the axis in the vertical direction.

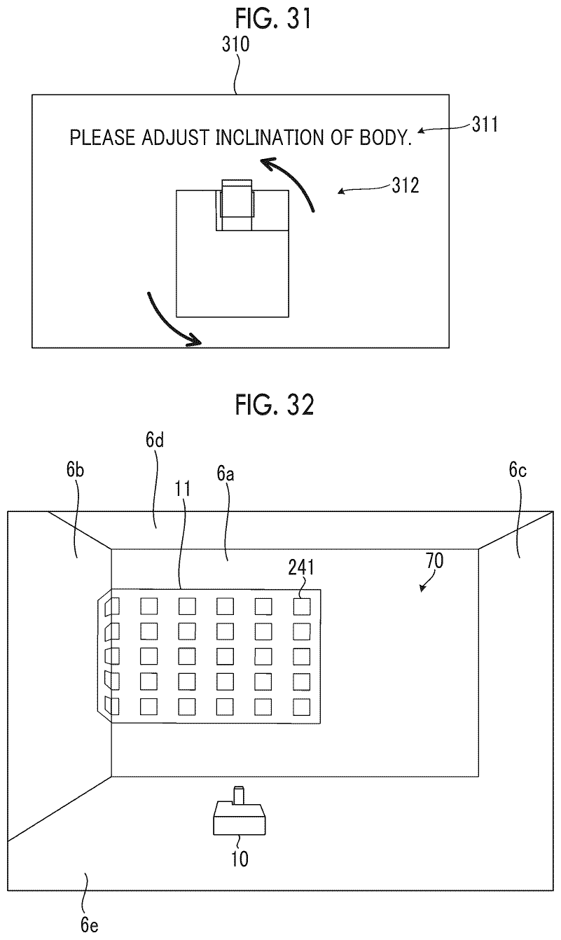

FIG. 31 is a diagram showing an example of display for prompting the adjustment of the inclination of the projection surface 11 in the example of FIG. 30. In the example shown in FIG. 30, the information processing terminal 50 displays, via the touch panel 51, a support image 310 including a message 311 of “Please adjust inclination of body.” and a guide image 312 for guiding to adjust the inclination such that the projection apparatus 10 is rotated about the vertical direction, in step S14 shown in FIG. 10. The support image 310 is an example of assist information for bringing the projection state via the projection apparatus 10 close to the projection state represented by the simulation result.

With the support image 310, the operator can easily recognize that the projection apparatus 10 is inclined in the rotation direction about the vertical direction with respect to the simulation result, and can adjust the inclination of the projection apparatus 10 in the rotation direction about the vertical direction to be substantially the same as the simulation result. In addition, the information processing terminal 50 may include guide information for guiding a method for adjusting the inclination of the projection apparatus 10 in the rotation direction about the vertical direction, and the like in the support image 310.

In addition, the information processing terminal 50 may output these types of assist information related to the inclination via voice in addition to or instead of the screen display. The output via the voice can be performed by, for example, a speaker included in the user interface 64.

In addition, the information processing terminal 50 may display the support image 310 shown in FIG. 31 by superimposing the support image 310 on the second image in which the virtual projection apparatus 10V and the virtual projection surface 11V are superimposed on the captured image (first image). The display image via the touch panel 51 in this case is an example of a third image in which the assist information is displayed on the second image.

In FIGS. 23 to 31, an example in which the marker grids 241 and 251 are used to specify the position of the plane has been described. There are, for example, the following two advantages in using the marker grids 241 and 251 to specify the position of the plane.

In order to describe the first advantage, for example, due to an error or a mistake in the setting of the virtual projection surface 11V, a part of the projected marker grid 241 may straddle the wall 6a and the wall 6b. FIG. 32 is a diagram showing an example of a state in which a part of the marker grid 241 straddles another plane (wall 6a and wall 6b). In the example of FIG. 32, five markers in one column on the left side of the marker grid 241 straddle the wall 6a and the wall 6b, and the information processing terminal 50 fails to detect the five markers.

In such a case, the information processing terminal 50 can detect the inclination of the projection surface 11 with respect to the virtual projection surface 11V by performing the conversion to the reference plane described in FIGS. 28 and 30 based on, without using the markers that straddle another plane (for example, markers that failed to be detected) out of the marker grid 241, the markers that do not straddle another plane (for example, markers that were successfully detected) and on the markers of the marker grid 251 corresponding to the markers that do not straddle another plane.

In a case of describing the second advantage, each marker of the marker grid 241 has a different shape and can be uniquely specified. Therefore, even in a case where imaging is performed such that only a part of the marker grid 241 is included in the imaging range 65a, the information processing terminal 50 can detect the inclination of the projection surface 11 with respect to the virtual projection surface 11V, for example, in a case where four markers of the marker grid 241 are included in the imaging range 65a.

### Correction of End of Projection Surface 11

Via the adjustment to step S14 shown in FIG. 10, the position and the posture of the projection apparatus 10 are adjusted in a state almost the same as the simulation results. In step S15 shown in FIG. 10, the end of the projection surface 11 is adjusted to match the virtual projection surface 11V.

FIG. 33 is a diagram showing an example of the marker grid 241 used for correcting an end of the projection surface 11. For example, as shown in FIG. 33, the information processing terminal 50 projects the marker grid 241 used for correcting the inclination of the projection apparatus 10 from the projection apparatus 10 onto the wall 6a. Meanwhile, here, only the markers 241a to 241d at the four corners of the marker grid 241 may be projected, and in the example of FIG. 33, only the markers 241a to 241d are projected.

FIG. 33 shows the markers 241a to 241d detected from the imaging data obtained by the information processing terminal 50 with the imaging apparatus 65, and the markers 251a to 251d of the virtual projection surface 11V. In the example of FIG. 33, the markers 241a to 241d slightly deviate with respect to the markers 251a to 251d. On the other hand, the information processing terminal 50 causes the projection apparatus 10 to execute the electronic shift or magnification/reduction of the projection surface 11 such that the markers 241a to 241d match the markers 251a to 251d. Accordingly, the end of the projection surface 11 can be finely adjusted to substantially coincide with the virtual projection surface 11V.

Before the electronic shifting or magnification/reduction, optical zooming via a zoom lens included in the projection optical system 23, optical shifting via the shift mechanism 105 or the like, or the like may be performed. In addition, in a case in which the markers 241a to 241d cannot be detected from the imaging data, the information processing terminal 50 may control the projection apparatus 10 to move the marker grid 241 until the markers 241a to 241d are detected by determining that the positions of the markers 251a to 251d are incorrect, that is, the markers 251a to 251d straddle the plane in the physical space 70.

### Case Where Projection Apparatus 10 Cannot be Installed on Ground Surface as in Simulation Result

In the above-described embodiment, a case where the projection apparatus 10 can be installed on the ground surface as in the simulation result in the physical space 70 has been described, but the present invention can also be applied to a case where the projection apparatus 10 cannot be installed on the ground surface as in the simulation result in the physical space 70.

For example, in a case where there is a simulation result in which the virtual projection apparatus 10V is installed on the ceiling 6d, the wall 6b, or the wall 6c, it may be difficult to install the projection apparatus 10 in accordance with the simulation result before the actual installation or construction of the projection apparatus 10.

FIG. 34 is a diagram showing an example of a simulation result of installing a virtual projection apparatus 10V on a ceiling 6d. In FIG. 34, a virtual space 70V is a virtual space representing the physical space 70, a virtual wall 6aV is a virtual wall representing the wall 6a, a virtual ceiling 6dV is a virtual ceiling representing the ceiling 6d, and a virtual floor 6eV is a virtual floor representing the floor 6e. In this example, it is possible to install the projection apparatus 10 on the floor 6e, but it is difficult to install the projection apparatus 10 on the ceiling 6d as in the simulation result at this point in time.

In this case, the information processing terminal 50 performs a simulation of maintaining the projection surface 11 (virtual projection surface 11V) in a state in which the projection apparatus 10 (virtual projection apparatus 10V) is installed on the floor 6e (virtual floor 6eV), and generates the virtual projection apparatus data and the virtual projection surface data indicating the simulation result. FIG. 35 is a diagram showing an example of a simulation result of installing the virtual projection apparatus 10V on a floor 6e. In this case, the virtual projection surface data is the same data as the original virtual projection surface data.

The information processing terminal 50 performs each processing described in FIG. 10 using the virtual projection apparatus data and the virtual projection surface data. As a result, the installation of the projection apparatus 10 cannot be reproduced as in the initial simulation result, but the projection surface 11 can be reproduced as in the simulation result.

As described in FIGS. 34 and 35, the information processing terminal 50 may generate and output the assist information for bringing the installation position (for example, the ground surface) of the projection apparatus 10 close to a position different from the installation position of the virtual projection apparatus represented by the virtual projection apparatus data and for bringing the state of the projection surface 11 close to the state of the virtual projection surface 11V represented by the virtual projection surface data.

### Case Where Projection Apparatus 10 Cannot be Installed at Position as in Simulation Result

In the above-described embodiment, a case where the projection apparatus 10 can be installed at the position as in the simulation result in the physical space 70 has been described, but the present invention can also be applied to a case where the projection apparatus 10 cannot be installed at the position as in the simulation result in the physical space 70.

For example, in steps S11 and S12 shown in FIG. 10, it is necessary to adjust the projector body via manual work of the operator, which takes time and effort. Therefore, in the adjustment shown in FIG. 10, it is also possible to omit steps S11 and S12, install the projection apparatus 10 at an appropriate installation form and installation position, and align the projection surface 11.

For example, in step S13 shown in FIG. 10, the projection conditions (screen ratio, optical zoom, optical lens shift mode, optical lens shift operation amount, and the like) of the projection apparatus 10 of the simulation result were used as they are. Meanwhile, in a case in which steps S11 and S12 are omitted, these projection conditions cannot be used in step S13. Therefore, the information processing terminal 50 performs, for example, processing of aligning the center of the projection surface 11.

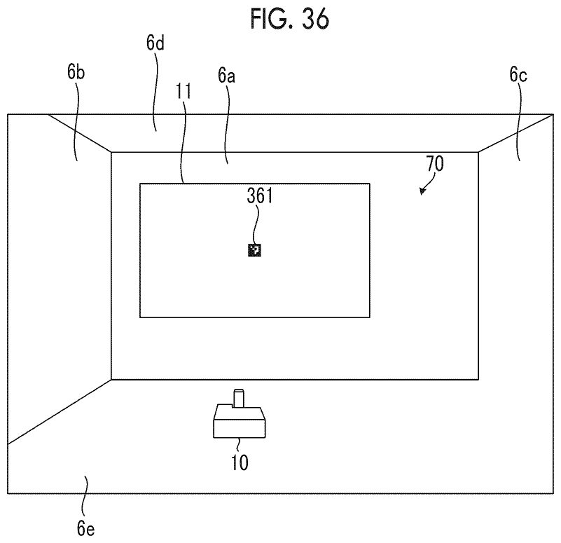

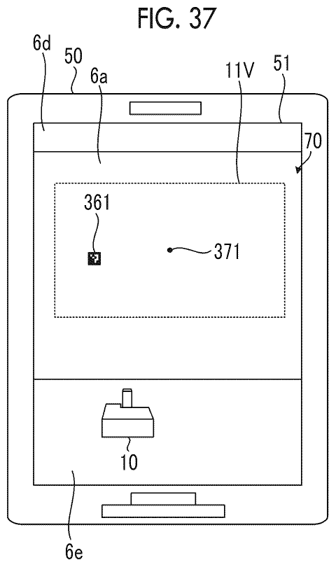

FIGS. 36 and 37 are diagrams showing an example of processing of aligning a center of the projection surface 11. For example, as shown in FIG. 36, the information processing terminal 50 projects a center marker 361 onto the center position of the projection surface 11 from the projection apparatus 10. In addition, the information processing terminal 50 detects the center marker 361 in each frame obtained by video imaging while performing video imaging of the center marker 361 with the imaging apparatus 65.

A virtual projection surface center 371 shown in FIG. 37 is a center position of the virtual projection surface 11V. The information processing terminal 50 gradually performs the lens shift of the projection apparatus 10 such that the detected center marker 361 approaches the virtual projection surface center 371. Thereafter, by executing steps S14 and S15 shown in FIG. 10, the installation of the projection apparatus 10 cannot be reproduced as in the simulation result, but the projection surface 11 can be reproduced as in the simulation result.

In the examples of FIGS. 36 and 37, the processing of video-processing and tracking one center marker 361 and performing the feedback each time to perform the registration has been described. However, as described in step S14 shown in FIG. 10, the registration between the planes may be performed using a plurality of markers such as the marker grids 241 and 251.

As described in FIGS. 36 and 37, the information processing terminal 50 may generate and output the assist information for bringing the state of the projection surface 11 close to the state of the virtual projection surface 11V represented by the virtual projection surface data at the installation position of the projection apparatus 10 based on the first image (captured image).

As described above, the information processing terminal 50 generates and outputs the second image data representing the second image in which the virtual projection surface and the virtual projection apparatus are displayed on the first image represented by the first image data, based on the virtual projection surface data related to the virtual projection surface 11V, the virtual projection apparatus data related to the virtual projection apparatus 10V, and the first image data obtained by the imaging apparatus 65.

In addition, the information processing terminal 50 generates and outputs assist information for bringing the projection state via the projection apparatus 10 (the installation state of the projection apparatus 10 or the state of the projection surface 11) close to the projection state represented by the virtual projection surface data or the virtual projection apparatus data. As a result, it is possible to efficiently adjust the projection state via the projection apparatus 10 such that the projection state (for example, the simulation result) represented by the virtual projection surface data or the virtual projection apparatus data is reproduced.

For example, the processor 61 may generate and output the third image data representing the third image in which the assist information is displayed on the second image, as an example of the output form of the assist information. In addition, the processor 61 may generate and output audio data representing the assist information as an example of the output form of the assist information. In addition, the processor 61 may generate and output the third image data representing the third image in which the assist information is displayed on the second image and the audio data representing the assist information by combining the output forms of the assist information.

The assist information is, for example, information representing a deviation between the installation state of the projection apparatus 10 and the installation state of the virtual projection apparatus represented by the virtual projection apparatus data. The installation state of the projection apparatus 10 includes at least one of the installation form of the projection apparatus 10 (for example, an installation style, a ground surface, a rotation state of a mount axis or a lens axis, or the like) or the installation position of the projection apparatus 10.

In addition, the information processing terminal 50 may generate the assist information based on the recognition result of the operator who installs the projection apparatus 10, which is included in the first image. As a result, it is possible to generate and output the assist information that is easy for the operator who installs the projection apparatus 10 to understand.

The state of the projection surface 11 out of the projection states via the projection apparatus 10 includes at least one of the position of the projection surface 11, the size of the projection surface 11, or the inclination of the projection surface 11. The size of the projection surface 11 is adjusted depending on a position between the projection apparatus 10 and the projection surface 11, a focal length of the projection apparatus 10, and the like.

For example, the information processing terminal 50 generates assist information for setting the projection condition (for example, the screen ratio, the optical zoom, the optical lens shift mode, the optical lens shift operation amount, and the like) of the projection apparatus 10 that changes at least one of the position or the size of the projection surface 11. In addition, the information processing terminal 50 may generate assist information for adjusting the inclination of the projection surface 11.

### Modification Example of Output Form of Assist Information

Although a configuration in which the output of the assist information is performed by the screen display via the touch panel 51 provided in the information processing terminal 50 or the voice output has been described, the output of the assist information may be performed by another device that can communicate with the information processing terminal 50. For example, the information processing terminal 50 may control the projection apparatus 10 to project the assist information from the projection apparatus 10 onto the projection surface 11.

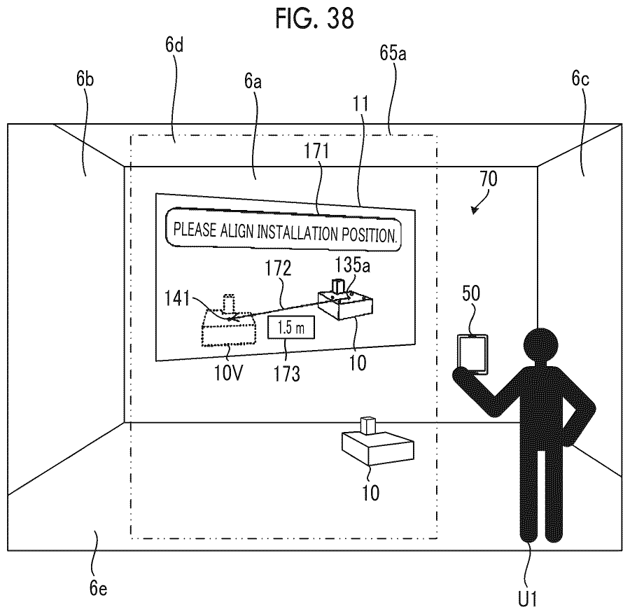

FIG. 38 is a diagram showing an example of the output of the assist information using the projection apparatus 10. For example, the information processing terminal 50 may perform control of transmitting the second image in which the virtual projection apparatus 10V and the virtual projection surface 11V are superimposed on the captured image (first image) and assist information to the projection apparatus 10 to project these types of information from the projection apparatus 10 onto the projection surface 11. While a configuration in which the assist information related to the adjustment of the installation position of the projection apparatus 10 is projected onto the projection apparatus 10 has been described in FIG. 38, a configuration in which other assist information is projected onto the projection apparatus 10 may be adopted.

In addition, the output form of the assist information via the voice output is not limited to the voice output of the message (language), and may be a non-language voice output such as a pulse sound in which a tempo is faster as getting closer to the simulation result. In addition, as the output form of the assist information, the length, intensity, or the like of the vibration via the information processing terminal 50 or a device communicable with the information processing terminal 50 may be used. In addition, as the output form of the assist information, a form in which the assist information is displayed to the operator by using display via a wearable display device worn by the operator who installs the projection apparatus 10, such as augmented reality (AR) glasses, may be used.

### Modification Example of Specification Method of Installation Position of Projection Apparatus 10

Although a configuration in which image recognition is used to specify the installation position of the projection apparatus 10 has been described, a configuration may be adopted in which the current installation position of the projection apparatus 10 is specified by using positioning via Bluetooth (registered trademark) or the like.

### Modification Example of Configuration of Projection Apparatus 10

While a configuration of bending the optical axis K twice using the reflective member 122 and the reflective member 32 has been described in FIG. 3 and FIG. 4 as the configuration of the projection apparatus 10, it may be configured to not bend the optical axis K by omitting the reflective member 122 and the reflective member 32, or it may be configured to bend the optical axis K once by omitting any of the reflective member 122 and the reflective member 32.

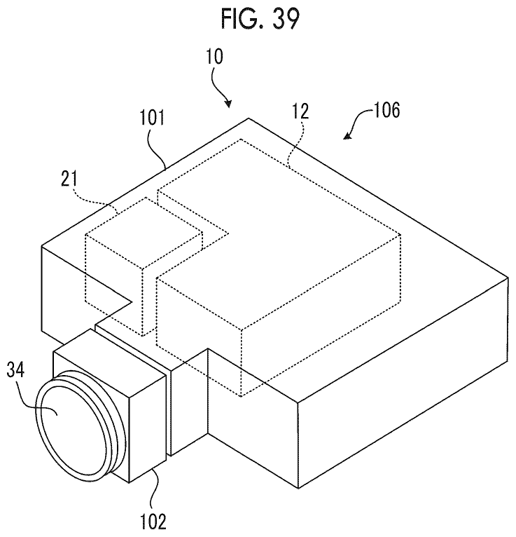

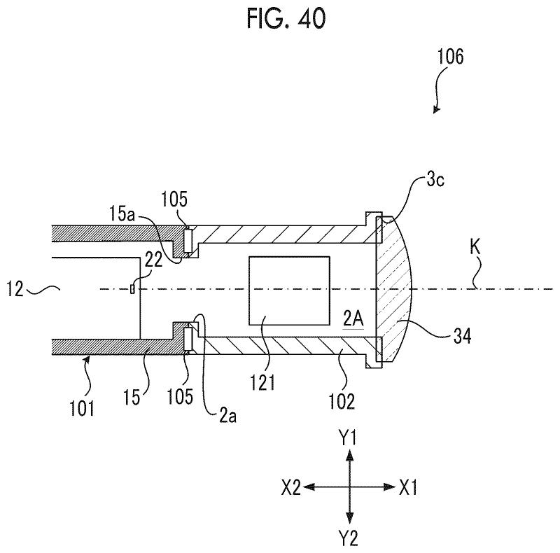

FIG. 39 is a schematic diagram showing another external configuration of the projection apparatus 10. FIG. 40 is a schematic cross-sectional view of the optical unit 106 of the projection apparatus 10 shown in FIG. 39. In FIGS. 39 and 40, the same parts as the parts shown in FIGS. 3 and 4 will be designated by the same reference numerals and will not be described.

The optical unit 106 shown in FIG. 39 comprises the first member 102 supported by the body part 101 and does not comprise the second member 103 shown in FIG. 3 and FIG. 4. In addition, the optical unit 106 shown in FIG. 39 does not comprise the reflective member 122, the second optical system 31, the reflective member 32, the third optical system 33, and the projection direction changing mechanism 104 shown in FIG. 3 and FIG. 4.

In the optical unit 106 shown in FIG. 39, the projection optical system 23 shown in FIG. 2 is composed of the first optical system 121 and of the lens 34. The optical axis K of the projection optical system 23 is shown in FIG. 40. The first optical system 121 and the lens 34 are disposed in this order from an optical modulation portion 22 side along the optical axis K.

The first optical system 121 guides the light that is incident on the first member 102 from the body part 101 and that travels in the direction X1, to the lens 34. The lens 34 is disposed in an end part of the body part 101 on the direction X1 side in the form of closing the opening 3c formed in this end part. The lens 34 projects the light incident from the first optical system 121 onto the projection surface 11.

Although the touch panel 51 of the information processing terminal 50 has been described as an example of the display device according to the embodiment of the present invention, the display device according to the embodiment of the present invention is not limited to the touch panel 51 and may be another display device (another display, the above-described AR glasses, or the like) that can communicate with the information processing terminal 50.

Although the imaging apparatus 65 of the information processing terminal 50 has been described as an example of the imaging apparatus according to the embodiment of the present invention, the imaging apparatus according to the embodiment of the present invention is not limited to the imaging apparatus 65 and may be another imaging apparatus that can communicate with the information processing terminal 50.

### Image Processing Program

The image processing method described in the above embodiment can be implemented by executing an image processing program prepared in advance on a computer. This image processing program is recorded in a computer-readable storage medium and is executed by being read from the storage medium by a computer. In addition, this image processing program may be provided in a form of being stored in a non-transitory storage medium, such as a flash memory, or may be provided via a network, such as the Internet. The computer that executes this image processing program may be included in an image processing apparatus (information processing terminal 50), may be included in an electronic apparatus such as a smartphone, a tablet terminal, or a personal computer capable of communicating with the image processing apparatus, or may be included in a server apparatus capable of communicating with the image processing apparatus and the electronic apparatus.

Although various embodiments have been described above, it goes without saying that the present invention is not limited to these examples. It is apparent that those skilled in the art may perceive various modification examples or correction examples within the scope disclosed in the claims, and those examples are also understood as falling within the technical scope of the present invention. In addition, each constituent in the embodiment may be used in any combination without departing from the gist of the invention.

The present application is based on Japanese Patent Application (JP2022-140823) filed on Sep. 5, 2022, the content of which is incorporated in the present application by reference.

### EXPLANATION OF REFERENCES

1: projection portion
2: operation reception portion
2A, 3A: hollow portion
2a, 2b, 3a, 3c, 15a: opening
4: control device
4a, 62: memory
6: projection object
6a, 6b, 6c: wall
6aV: virtual wall
6d: ceiling
6dV: virtual ceiling
6e: floor
6eV: virtual floor
10: projection apparatus
10V: virtual projection apparatus
11: projection surface
11V: virtual projection surface
12: optical modulation unit
15: housing
21: light source
22: optical modulation portion
23: projection optical system
24: control circuit
31: second optical system
32, 122: reflective member
33: third optical system
34: lens
50: information processing terminal
51: touch panel
61: processor
63: communication interface
64: user interface
65: imaging apparatus
65a: imaging range
65b: captured image
66: space recognition sensor
69: bus
70: physical space
70V: virtual space
101: body part
102: first member
103: second member
104: projection direction changing mechanism
105: shift mechanism
106: optical unit
111 to 113, 131 to 135, 241a to 241d, 251a to 251d: marker
120, 171, 291, 311: message
121: first optical system
131a, 132a, 133a, 134a: point
135a, 141: reference point
172: movement direction information
173: moving distance information
211: movement direction
221: tripod
241, 251: marker grid
261 to 264, 271 to 274: corner position
290, 310: support image
292, 312: guide image
361: center marker
371: virtual projection surface center
G1: image
U1: user
D1: distance

What is claimed is:

1. An image processing apparatus comprising a processor,
wherein the processor is configured to:
acquire virtual projection surface data related to a virtual projection surface and virtual projection apparatus data related to a virtual projection apparatus;
acquire first image data obtained by an imaging apparatus;
generate second image data representing a second image in which the virtual projection surface and the virtual projection apparatus are displayed on a first image represented by the first image data, based on the first image data, the virtual projection surface data, and the virtual projection apparatus data, and output the second image data to an output destination; and
generate assist information representing a deviation between an installation state of a projection apparatus based on the first image and an installation state of the virtual projection apparatus represented by the virtual projection apparatus data, based on a recognition result of an operator who installs the projection apparatus, which is included in the first image.

2. The image processing apparatus according to claim 1,
wherein the processor is configured to generate third image data representing a third image in which the assist information is displayed on the second image and output the third image data to the output destination.

3. The image processing apparatus according to claim 1,
wherein the processor is configured to generate audio data representing the assist information and output the audio data to the output destination.

4. The image processing apparatus according to claim 1,
wherein the installation state of the projection apparatus includes at least one of an installation form of the projection apparatus or an installation position of the projection apparatus.

5. The image processing apparatus according to claim 1,
Wherein the assist information is information for bringing a projection state via a projection apparatus close to a projection state represented by at least one of the virtual projection surface data or the virtual projection apparatus data,
the projection state includes the state of the projection surface, and
the state of the projection surface includes at least one of a position of the projection surface, a size of the projection surface, or an inclination of the projection surface.

6. The image processing apparatus according to claim 5,
wherein the state of the projection surface includes at least one of the position or the size of the projection surface, and
the processor is configured to generate the assist information for setting a projection condition of the projection apparatus that changes at least one of the position or the size of the projection surface.

7. The image processing apparatus according to claim 5,
wherein the state of the projection surface includes the inclination of the projection surface, and
the processor is configured to generate the assist information for adjusting the inclination of the projection surface.

8. The image processing apparatus according to claim 1,
wherein the processor is configured to generate the assist information for bringing an installation position of the projection apparatus close to a position different from an installation position of the virtual projection apparatus represented by the virtual projection apparatus data and for bringing a state of a projection surface corresponding to the projection apparatus close to a state of the virtual projection surface represented by the virtual projection surface data.

9. The image processing apparatus according to claim 1,
wherein the processor is configured to generate the assist information for bringing a state of a projection surface corresponding to the projection apparatus close to a state of the virtual projection surface represented by the virtual projection surface data at an installation position of the projection apparatus based on the first image.

10. The image processing apparatus according to claim 1,
wherein the output destination includes the projection apparatus capable of projecting the assist information.

11. The image processing apparatus according to claim 1,
wherein the output destination includes a wearable display device that is worn by an operator who installs the projection apparatus and that is capable of displaying the assist information.

12. The image processing apparatus according to claim 1,
wherein the image processing apparatus is provided in an information processing terminal comprising a display device capable of displaying the assist information, and
the output destination includes the display device.

13. The image processing apparatus according to claim 12,
wherein the information processing terminal comprises the imaging apparatus.

14. An image processing method executed by a processor included in an image processing apparatus, the image processing method comprising:
acquiring virtual projection surface data related to a virtual projection surface and virtual projection apparatus data related to a virtual projection apparatus;
acquiring first image data obtained by an imaging apparatus;
generating second image data representing a second image in which the virtual projection surface and the virtual projection apparatus are displayed on a first image represented by the first image data, based on the first image data, the virtual projection surface data, and the virtual projection apparatus data, and outputting the second image data to an output destination; and
generating assist information representing a deviation between the installation state of a projection apparatus based on the first image and an installation state of the virtual projection apparatus represented by the virtual projection apparatus data, based on a recognition result of an operator who installs the projection apparatus, which is included in the first image

15. A non-transitory computer-readable storage medium storing an image processing program for causing a processor included in an image processing apparatus to execute a process comprising:
acquiring virtual projection surface data related to a virtual projection surface and virtual projection apparatus data related to a virtual projection apparatus;
acquiring first image data obtained by an imaging apparatus;
generating second image data representing a second image in which the virtual projection surface and the virtual projection apparatus are displayed on a first image represented by the first image data, based on the first image data, the virtual projection surface data, and the virtual projection apparatus data, and outputting the second image data to an output destination; and
generating assist information representing a deviation between the installation state of a projection apparatus based on the first image and an installation state of the virtual projection apparatus represented by the virtual projection apparatus data, based on a recognition result of an operator who installs the projection apparatus, which is included in the first image.

16. A system comprising:
an image processing apparatus;
an imaging apparatus; and
a projection apparatus,
wherein virtual projection surface data related to a virtual projection surface and virtual projection apparatus data related to a virtual projection apparatus are acquired,
first image data obtained by the imaging apparatus is acquired,
second image data representing a second image in which the virtual projection surface and the virtual projection apparatus are displayed on a first image represented by the first image data is generated based on the first image data, the virtual projection surface data, and the virtual projection apparatus data and the second image data is output to an output destination, and
assist information is generated and the assist information is output to the output destination, the assist information representing a deviation between the installation state of the projection apparatus based on the first image and an installation state of the virtual projection apparatus represented by the virtual projection apparatus data, based on a recognition result of an operator who installs the projection apparatus, which is included in the first image.
